(19) United States
(12) Patent Application Publication
(10) Pub. No.: US 2018/0198554 A1
(43) Pub. Date: Jul. 12, 2018

(54) DATA TRANSMISSION METHOD AND APPARATUS BASED ON UNEQUAL ERROR PROTECTION AND DEVICE

(71) Applicant: HUAWEI TECHNOLOGIES CO., LTD., Shenzhen (CN)

(72) Inventors: Hao WANG, Beijing (CN); Haiyun SUN, Beijing (CN); Tongyu LIN, Beijing (CN); Yumei WANG, Beijing (CN); Chunchang TIAN, Shanghai (CN)

(21) Appl. No.: 15/864,201

(22) Filed: Jan. 8, 2018

Related U.S. Application Data
(63) Continuation of application No. PCT/CN2015/084374, filed on Jul. 17, 2015.

(51) Int. Cl. H04L 1/00

(52) U.S. Cl. CPC H04L 1/007; H04L 1/0009; H04L 27/34; H04L 1/0041; H04L 1/0071

(57) ABSTRACT

Embodiments of the present invention relate to a data transmission method and apparatus based on unequal error protection and a device. The method includes: segmenting, according to a quantity of symbol bits in a constellation diagram, a code block corresponding to data, to obtain segmented code blocks; performing rate matching on the segmented code blocks obtained by channel encoding, to obtain output code blocks; cascading the output code blocks according to the quantity of symbol bits in the constellation diagram, to obtain cascaded code blocks; and sending the cascaded code blocks to a terminal device.

### CROSS-REFERENCE TO RELATED APPLICATION

This application is a continuation of International Application No. PCT/CN2015/084374, filed on Jul. 17, 2015, the disclosure of which is hereby incorporated by reference in its entirety.

### TECHNICAL FIELD

Embodiments of the present invention relate to communications technologies, and in particular, to a data transmission method and apparatus based on unequal error protection and a device.

### BACKGROUND

In addition to a feature of a large data amount, video data has a feature of generating, by means of encoding in a video encoding process, a data stream that affects, in different degrees, a receive end to perform decoding to restore the video data. Therefore, how to perform encoding according to importance of the video data to effectively protect data is a quite important issue.

In the prior art, video data is prioritized according to importance of the video data. After the video data is divided into different queues according to different priorities, the queues are sent to a convolutional encoder, and the convolutional encoder sends the queues to a comb filter. In the comb filter, according to a greedy algorithm, a high-priority data bit is placed into a location of a most significant bit (Most Significant Bit, MSB for short) of a modulation symbol, and a low-priority data bit is placed into a location of a least significant bit (Least Significant Bit, LSB for short) of the modulation symbol. In this way, data can be effectively protected.

However, a channel encoding manner used in the prior art is convolutional code, and before entering an encoder, the video data needs to be divided into different queues according to importance. Turbo encoding is used in a Long Term Evolution (Long Term Evolution, LTE for short) system. In addition, importance of the video data cannot be distinguished. Therefore, an existing video data protection manner is not applicable to the LTE system.

### SUMMARY

Embodiments of the present invention provide a data transmission method and apparatus based on unequal error protection and a device, so that unequal error protection for video data is implemented in an LTE system.

According to a first aspect, an embodiment of the present invention provides a data transmission method based on unequal error protection, including:

segmenting, according to a quantity of symbol bits in a constellation diagram, a code block corresponding to data, to obtain segmented code blocks;

performing rate matching on the segmented code blocks obtained by channel encoding, to obtain output code blocks;

cascading the output code blocks according to the quantity of symbol bits in the constellation diagram, to obtain cascaded code blocks; and

sending the cascaded code blocks to a terminal device.

With reference to the first aspect, in a first possible implementation of the first aspect, the segmenting, according to a quantity of symbol bits in a constellation diagram, a code block corresponding to data includes:

determining a segment quantity according to the quantity Qₘ of symbol bits in the constellation diagram, where the segment quantity is an integer multiple of Qₘ/2; and

segmenting the code block according to the segment quantity.

With reference to the first possible implementation of the first aspect, in a second possible implementation of the first aspect, the determining a segment quantity according to the quantity Qₘ of symbol bits in the constellation diagram includes:

determining the segment quantity C′ according to a formula

$${C}^{′} = \frac{{Q}_{m}}{2} * ⌈ \frac{B}{( Z - L ) * {Q}_{m} / 2} ⌉ ,$$

where Z represents a maximum value of a code block size, B represents a magnitude of an input bit stream corresponding to the code block, and L represents a magnitude of a CRC parity bit.

With reference to the first or the second possible implementation of the first aspect, in a third possible implementation of the first aspect, the cascading the output code blocks according to the quantity of symbol bits in the constellation diagram includes:

using every Qₘ/2 output code blocks as a code block group, and sorting the output code blocks in each code block group according to importance of the data; and

separately obtaining one bit from each sorted output code block corresponding to each code block group and cascading the obtained bits, and repeating this operation until Qₘ bits are cascaded.

With reference to any one of the first aspect, or the first to the third possible implementations of the first aspect, in a fourth possible implementation of the first aspect, the performing rate matching on the segmented code blocks obtained by channel encoding includes:

encoding the segmented code blocks to obtain encoded code blocks;

performing interleaving processing on the encoded code blocks by using an interleaver, to obtain interleaved code blocks; and

performing rate matching on the interleaved code blocks to obtain the output code blocks.

With reference to any one of the first aspect, or the first to the fourth possible implementations of the first aspect, in a fifth possible implementation of the first aspect, the sending the cascaded code blocks to a terminal device includes:

performing data modulation on the cascaded code blocks to obtain modulated data;

performing digital-to-analog conversion on the modulated data to obtain analog data; and

sending the analog data to the terminal device.

According to a second aspect, an embodiment of the present invention provides a data transmission method based on unequal error protection, including:

segmenting, according to a preset parameter, a code block corresponding to data, to obtain segmented code blocks;

performing encoding processing on the segmented code blocks to obtain encoded code blocks, where the encoded code blocks include system bit code blocks;

performing interleaving processing on the system bit code blocks according to a quantity of symbol bits in a constellation diagram, to obtain interleaved code blocks; and

cascading the interleaved code blocks to obtain cascaded code blocks, and sending the cascaded code blocks to a terminal device.

With reference to the second aspect, in a first possible implementation of the second aspect, the segmenting, according to a preset parameter, a code block corresponding to data includes:

determining a segment quantity, a length of a segmented code block, and a quantity of first padding bits according to the preset parameter, where the padding bit is a bit used when bit padding is performed on the code block; and

performing bit padding on the code block according to the segment quantity, the length of a segmented code block, and the quantity of first padding bits, so as to segment the code block.

With reference to the first possible implementation of the second aspect, in a second possible implementation of the second aspect, the performing interleaving processing on the system bit code blocks according to a quantity of symbol bits in a constellation diagram includes:

determining a quantity of rows of an interleaver according to the quantity of symbol bits in the constellation diagram, and determining a quantity of second padding bits according to the quantity of rows of the interleaver and a preset quantity of columns of the interleaver; and

separately placing the padding bit and an information bit according to the quantity of second padding bits and the quantity of symbol bits in the constellation diagram, where the information bit is a bit corresponding to the data.

According to a third aspect, an embodiment of the present invention provides a data transmission method based on unequal error protection, including:

receiving cascaded code blocks sent by a base station, where the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram;

performing code block splitting on the cascaded code blocks according to the quantity of symbol bits in the constellation diagram, to obtain split code blocks; and

performing code block cascading on the split code blocks obtained by channel decoding, to obtain the data.

With reference to the third aspect, in a first possible implementation of the third aspect, the performing code block splitting on the cascaded code blocks according to the quantity of symbol bits in the constellation diagram includes:

using every Qₘ/2 bits in the cascaded code blocks as a bit group, sequentially obtaining one bit from each bit group, and forming a bit stream by using the obtained bits.

With reference to the third aspect or the first possible implementation of the third aspect, in a second possible implementation of the third aspect, the performing code block cascading on the split code blocks obtained by channel decoding includes:

performing de-interleaving processing on the split code blocks by using a de-interleaver, to obtain de-interleaved code blocks;

performing decoding processing on the de-interleaved code blocks to obtain decoded code blocks; and

sequentially performing CRC check and code block cascading processing on the decoded code blocks, to obtain the data.

According to a fourth aspect, an embodiment of the present invention provides a data transmission method based on unequal error protection, including:

receiving cascaded code blocks sent by a base station, where the cascaded code blocks are obtained after a code block corresponding to data is segmented according to a preset parameter, encoding processing is performed on the obtained segmented code blocks to obtain encoded code blocks, where the encoded code blocks include system bit code blocks, interleaving processing is performed on the system bit code blocks according to a quantity of symbol bits in a constellation diagram to obtain interleaved code blocks, and the interleaved code blocks are cascaded;

performing LTE data receiving processing on the cascaded code blocks to obtain check code blocks; and

performing row-in-column-out code block cascading on the check code blocks to obtain cascaded code blocks.

With reference to the fourth aspect, in a first possible implementation of the fourth aspect, the performing LTE data receiving processing on the cascaded code block includes:

performing code block splitting on the cascaded code blocks to obtain split code blocks;

performing de-interleaving processing on the split code blocks to obtain de-interleaved code blocks;

performing decoding processing on the de-interleaved code blocks to obtain decoded code blocks; and

checking the decoded code blocks to obtain the check code blocks.

According to a fifth aspect, an embodiment of the present invention provides a data transmission apparatus based on unequal error protection, including:

a segmentation module, configured to segment, according to a quantity of symbol bits in a constellation diagram, a code block corresponding to data, to obtain segmented code blocks;

a matching module, configured to perform rate matching on the segmented code blocks obtained by channel encoding, to obtain output code blocks;

a cascading module, configured to cascade the output code blocks according to the quantity of symbol bits in the constellation diagram, to obtain cascaded code blocks; and

a sending module, configured to send the cascaded code blocks to a terminal device.

With reference to the fifth aspect, in a first possible implementation of the fifth aspect, the segmentation module includes:

a determining unit, configured to determine a segment quantity according to the quantity Qₘ of symbol bits in the constellation diagram, where the segment quantity is an integer multiple of Qₘ/2; and

a segmentation unit, configured to segment the code block according to the segment quantity.

With reference to the first possible implementation of the fifth aspect, in a second possible implementation of the fifth aspect, the determining unit is specifically configured to:

determine the segment quantity C′ according to a formula

$${C}^{′} = \frac{{Q}_{m}}{2} * ⌈ \frac{B}{( Z - L ) * {Q}_{m} / 2} ⌉ ,$$

where Z represents a maximum value of a code block size, B represents a magnitude of an input bit stream corresponding to the code block, and L represents a magnitude of a CRC parity bit.

With reference to the first or the second possible implementation of the fifth aspect, in a third possible implementation of the fifth aspect, the cascading module includes:

a sorting unit, configured to use every Qₘ/2 output code blocks as a code block group, and sort the output code blocks in each code block group according to importance of the data; and

an obtaining unit, configured to separately obtain one bit from each sorted output code block corresponding to each code block group and cascade the obtained bits, and repeat this operation until Qₘ bits are cascaded.

With reference to any one of the fifth aspect, or the first to the third possible implementations of the fifth aspect, in a fourth possible implementation of the fifth aspect, the matching module includes:

an encoding unit, configured to encode the segmented code blocks to obtain encoded code blocks;

an interleaving unit, configured to perform interleaving processing on the encoded code blocks by using an interleaver, to obtain interleaved code blocks; and

a matching unit, configured to perform rate matching on the interleaved code blocks to obtain the output code blocks.

With reference to any one of the fifth aspect, or the first to the fourth possible implementations of the fifth aspect, in a fifth possible implementation of the fifth aspect, the apparatus further includes:

a modulation module, configured to perform data modulation on the cascaded code blocks to obtain modulated data; and

a conversion module, configured to perform digital-to-analog conversion on the modulated data to obtain analog data; where

the sending module is further configured to send the analog data to the terminal device.

According to a sixth aspect, an embodiment of the present invention provides a data transmission apparatus based on unequal error protection, including:

a segmentation module, configured to segment, according to a preset parameter, a code block corresponding to data, to obtain segmented code blocks;

an encoding module, configured to perform encoding processing on the segmented code blocks to obtain encoded code blocks, where the encoded code blocks include system bit code blocks;

an interleaving module, configured to perform interleaving processing on the system bit code blocks according to a quantity of symbol bits in a constellation diagram, to obtain interleaved code blocks;

a cascading module, configured to cascade the interleaved code blocks to obtain cascaded code blocks; and

a sending module, configured to send the cascaded code blocks to a terminal device.

With reference to the sixth aspect, in a first possible implementation of the sixth aspect, the segmentation module includes:

a first determining unit, configured to determine a segment quantity, a length of a segmented code block, and a quantity of first padding bits according to the preset parameter, where the padding bit is a bit used when bit padding is performed on the code block; and

a padding unit, configured to perform bit padding on the code block according to the segment quantity, the length of a segmented code block, and the quantity of first padding bits, so as to segment the code block.

With reference to the first possible implementation of the sixth aspect, in a second possible implementation of the sixth aspect, the interleaving module includes:

a second determining unit, configured to determine a quantity of rows of an interleaver according to the quantity of symbol bits in the constellation diagram, and determine a quantity of second padding bits according to the quantity of rows of the interleaver and a preset quantity of columns of the interleaver; and

a placing unit, configured to separately place the padding bit and an information bit according to the quantity of second padding bits and the quantity of symbol bits in the constellation diagram, where the information bit is a bit corresponding to the data.

According to a seventh aspect, an embodiment of the present invention provides a data transmission apparatus based on unequal error protection, including:

a receiving module, configured to receive cascaded code blocks sent by a base station, where the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram;

a splitting module, configured to perform code block splitting on the cascaded code blocks according to the quantity of symbol bits in the constellation diagram, to obtain split code blocks; and

a cascading module, configured to perform code block cascading on the split code blocks obtained by channel decoding, to obtain the data.

With reference to the seventh aspect, in a first possible implementation of the seventh aspect, the splitting module is specifically configured to use every Qₘ/2 bits in the cascaded code blocks as a bit group, sequentially obtain one bit from each bit group, and form a bit stream by using the obtained bits.

With reference to the seventh aspect or the first possible implementation of the seventh aspect, in a second possible implementation of the seventh aspect, the cascading module includes:

a de-interleaving unit, configured to perform de-interleaving processing on the split code blocks by using a de-interleaver, to obtain de-interleaved code blocks;

a decoding unit, configured to perform decoding processing on the de-interleaved code blocks to obtain decoded code blocks; and

a processing unit, configured to sequentially perform CRC check and code block cascading processing on the decoded code blocks, to obtain the data.

According to an eighth aspect, an embodiment of the present invention provides a data transmission apparatus based on unequal error protection, including:

a receiving module, configured to receive cascaded code blocks sent by a base station, where the cascaded code blocks are obtained after a code block corresponding to data is segmented according to a preset parameter, encoding processing is performed on the obtained segmented code blocks to obtain encoded code blocks, where the encoded code blocks include system bit code blocks, interleaving processing is performed on the system bit code blocks according to a quantity of symbol bits in a constellation diagram to obtain interleaved code blocks, and the interleaved code blocks are cascaded;

a processing module, configured to perform LTE data receiving processing on the cascaded code blocks to obtain check code blocks; and

a cascading module, configured to perform row-in-column-out code block cascading on the check code blocks to obtain cascaded code blocks.

With reference to the eighth aspect, in a first possible implementation of the eighth aspect, the processing module includes:

a splitting unit, configured to perform code block splitting on the cascaded code blocks to obtain split code blocks;

a de-interleaving unit, configured to perform de-interleaving processing on the split code blocks to obtain de-interleaved code blocks;

a decoding unit, configured to perform decoding processing on the de-interleaved code blocks to obtain decoded code blocks; and

a check unit, configured to check the decoded code blocks to obtain the check code blocks.

According to a ninth aspect, an embodiment of the present invention provides a base station, including:

a processor, configured to segment, according to a quantity of symbol bits in a constellation diagram, a code block corresponding to data, to obtain segmented code blocks, where

the processor is further configured to perform rate matching on the segmented code blocks obtained by channel encoding, to obtain output code blocks; and

the processor is further configured to cascade the output code blocks according to the quantity of symbol bits in the constellation diagram, to obtain cascaded code blocks; and

a transmitter, configured to send the cascaded code blocks to a terminal device.

With reference to the ninth aspect, in a first possible implementation of the ninth aspect, the processor is further configured to determine a segment quantity according to the quantity Qₘ of symbol bits in the constellation diagram, where the segment quantity is an integer multiple of Qₘ/2; and

the processor is further configured to segment the code block according to the segment quantity.

With reference to the first possible implementation of the ninth aspect, in a second possible implementation of the ninth aspect, the processor is further configured to determine the segment quantity C′ according to a formula

$${C}^{′} = \frac{{Q}_{m}}{2} * ⌈ \frac{B}{( Z - L ) * {Q}_{m} / 2} ⌉ ,$$

where Z represents a maximum value of a code block size, B represents a magnitude of an input bit stream corresponding to the code block, and L represents a magnitude of a CRC parity bit.

With reference to the first or the second possible implementation of the ninth aspect, in a third possible implementation of the ninth aspect, the processor is further configured to use every Qₘ/2 output code blocks as a code block group, and sort the output code blocks in each code block group according to importance of the data; and

the processor is further configured to separately obtain one bit from each sorted output code block corresponding to each code block group and cascade the obtained bits, and repeat this operation until Qₘ bits are cascaded.

With reference to any one of the ninth aspect, or the first to the third possible implementations of the ninth aspect, in a fourth possible implementation of the ninth aspect, the processor is further configured to encode the segmented code blocks to obtain encoded code blocks;

the processor is further configured to perform interleaving processing on the encoded code blocks by using an interleaver, to obtain interleaved code blocks; and

the processor is further configured to perform rate matching on the interleaved code blocks to obtain the output code blocks.

With reference to any one of the ninth aspect, or the first to the fourth possible implementations of the ninth aspect, in a fifth possible implementation of the ninth aspect, the processor is further configured to perform data modulation on the cascaded code blocks to obtain modulated data;

the processor is further configured to perform digital-to-analog conversion on the modulated data to obtain analog data; and

the transmitter is further configured to send the analog data to the terminal device.

According to a tenth aspect, an embodiment of the present invention provides a base station, including:

a processor, configured to segment, according to a preset parameter, a code block corresponding to data, to obtain segmented code blocks, where

the processor is further configured to perform encoding processing on the segmented code blocks to obtain encoded code blocks, where the encoded code blocks include system bit code blocks;

the processor is further configured to perform interleaving processing on the system bit code blocks according to a quantity of symbol bits in a constellation diagram, to obtain interleaved code blocks; and

the processor is further configured to cascade the interleaved code blocks to obtain cascaded code blocks; and

a transmitter, configured to send the cascaded code blocks to a terminal device.

With reference to the tenth aspect, in a first possible implementation of the tenth aspect, the processor is further configured to determine a segment quantity, a length of a segmented code block, and a quantity of first padding bits according to the preset parameter, where the padding bit is a bit used when bit padding is performed on the code block; and

the processor is further configured to perform bit padding on the code block according to the segment quantity, the length of a segmented code block, and the quantity of first padding bits, so as to segment the code block.

With reference to the first possible implementation of the tenth aspect, in a second possible implementation of the tenth aspect, the processor is further configured to determine a quantity of rows of an interleaver according to the quantity of symbol bits in the constellation diagram, and determine a quantity of second padding bits according to the quantity of rows of the interleaver and a preset quantity of columns of the interleaver; and

the processor is further configured to separately place the padding bit and an information bit according to the quantity of second padding bits and the quantity of symbol bits in the constellation diagram, where the information bit is a bit corresponding to the data.

According to an eleventh aspect, an embodiment of the present invention provides a terminal device, including:

a receiver, configured to receive cascaded code blocks sent by a base station, where the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram; and

a processor, configured to perform code block splitting on the cascaded code blocks according to the quantity of symbol bits in the constellation diagram, to obtain split code blocks, where

the processor is further configured to perform code block cascading on the split code blocks obtained by channel decoding, to obtain the data.

With reference to the eleventh aspect, in a first possible implementation of the eleventh aspect, the processor is further configured to use every Qₘ/2 bits in the cascaded code blocks as a bit group, sequentially obtain one bit from each bit group, and form a bit stream by using the obtained bits.

With reference to the eleventh aspect or the first possible implementation of the eleventh aspect, in a second possible implementation of the eleventh aspect, the processor is further configured to perform de-interleaving processing on the split code blocks by using a de-interleaver, to obtain de-interleaved code blocks;

the processor is further configured to perform decoding processing on the de-interleaved code blocks to obtain decoded code blocks; and

the processor is further configured to sequentially perform CRC check and code block cascading processing on the decoded code blocks, to obtain the data.

According to a twelfth aspect, an embodiment of the present invention provides a terminal device, including:

a receiver, configured to receive cascaded code blocks sent by a base station, where the cascaded code blocks are obtained after a code block corresponding to data is segmented according to a preset parameter, encoding processing is performed on the obtained segmented code blocks to obtain encoded code blocks, where the encoded code blocks include system bit code blocks, interleaving processing is performed on the system bit code blocks according to a quantity of symbol bits in a constellation diagram to obtain interleaved code blocks, and the interleaved code blocks are cascaded; and

a processor, configured to perform LTE data receiving processing on the cascaded code blocks to obtain check code blocks, where

the processor is further configured to perform row-in-column-out code block cascading on the check code blocks to obtain cascaded code blocks.

With reference to the twelfth aspect, in a first possible implementation of the twelfth aspect, the processor is further configured to perform code block splitting on the cascaded code blocks to obtain split code blocks;

the processor is further configured to perform de-interleaving processing on the split code blocks to obtain de-interleaved code blocks;

the processor is further configured to perform decoding processing on the de-interleaved code blocks to obtain decoded code blocks; and

the processor is further configured to check the decoded code blocks to obtain the check code blocks.

According to the data transmission method and apparatus based on unequal error protection and the device provided in the embodiments of the present invention, the code block corresponding to the data is segmented according to the quantity of symbol bits in the constellation diagram to obtain the segmented code blocks, rate matching is performed on the segmented code blocks obtained by channel encoding to obtain the output code blocks, the output code blocks are cascaded according to the quantity of symbol bits in the constellation diagram to obtain the cascaded code blocks, and the cascaded code blocks are sent to the terminal device. The base station performs segmentation and cascading processing on the code block according to the quantity of symbol bits in the constellation diagram, so that important data is mapped to a location with a lower bit error rate in the constellation diagram. In this way, a purpose of unequal error protection for data can also be achieved in an LTE system.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic architecture diagram of an application scenario of a data transmission method based on unequal error protection according to the present invention;

FIG. 2 is a schematic flowchart of Embodiment 1 of a data transmission method based on unequal error protection according to the present invention;

FIG. 3 is a schematic flowchart of Embodiment 2 of a data transmission method based on unequal error protection according to the present invention;

FIG. 4 is a schematic diagram of a result of code block segmentation;

FIG. 5 shows a rate matching process in an LTE network;

FIG. 6 is a schematic diagram of a code block cascading process;

FIG. 7 is a schematic flowchart of Embodiment 3 of a data transmission method based on unequal error protection according to the present invention;

FIG. 8 is a schematic flowchart of Embodiment 4 of a data transmission method based on unequal error protection according to the present invention;

FIG. 9 is a schematic flowchart of Embodiment 5 of a data transmission method based on unequal error protection according to the present invention;

FIG. 10 is a schematic flowchart of Embodiment 6 of a data transmission method based on unequal error protection according to the present invention;

FIG. 11 is a schematic diagram of segmentation processing;

FIG. 12 is a schematic diagram of interleaving processing;

FIG. 13 is a schematic flowchart of Embodiment 7 of a data transmission method based on unequal error protection according to the present invention;

FIG. 14 is a schematic structural diagram of Embodiment 1 of a data transmission apparatus based on unequal error protection according to the present invention;

FIG. 15 is a schematic structural diagram of Embodiment 2 of a data transmission apparatus based on unequal error protection according to the present invention;

FIG. 16 is a schematic structural diagram of Embodiment 3 of a data transmission apparatus based on unequal error protection according to the present invention;

FIG. 17 is a schematic structural diagram of Embodiment 4 of a data transmission apparatus based on unequal error protection according to the present invention;

FIG. 18 is a schematic structural diagram of Embodiment 5 of a data transmission apparatus based on unequal error protection according to the present invention;

FIG. 19 is a schematic structural diagram of Embodiment 6 of a data transmission apparatus based on unequal error protection according to the present invention;

FIG. 20 is a schematic structural diagram of Embodiment 7 of a data transmission apparatus based on unequal error protection according to the present invention;

FIG. 21 is a schematic structural diagram of Embodiment 8 of a data transmission apparatus based on unequal error protection according to the present invention;

FIG. 22 is a schematic structural diagram of Embodiment 9 of a data transmission apparatus based on unequal error protection according to the present invention;

FIG. 23 is a schematic structural diagram of Embodiment 10 of a data transmission apparatus based on unequal error protection according to the present invention;

FIG. 24 is a schematic structural diagram of Embodiment 1 of a base station according to the present invention;

FIG. 25 is a schematic structural diagram of Embodiment 2 of a base station according to the present invention;

FIG. 26 is a schematic structural diagram of Embodiment 1 of a terminal device according to the present invention; and

FIG. 27 is a schematic structural diagram of Embodiment 2 of a terminal device according to the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

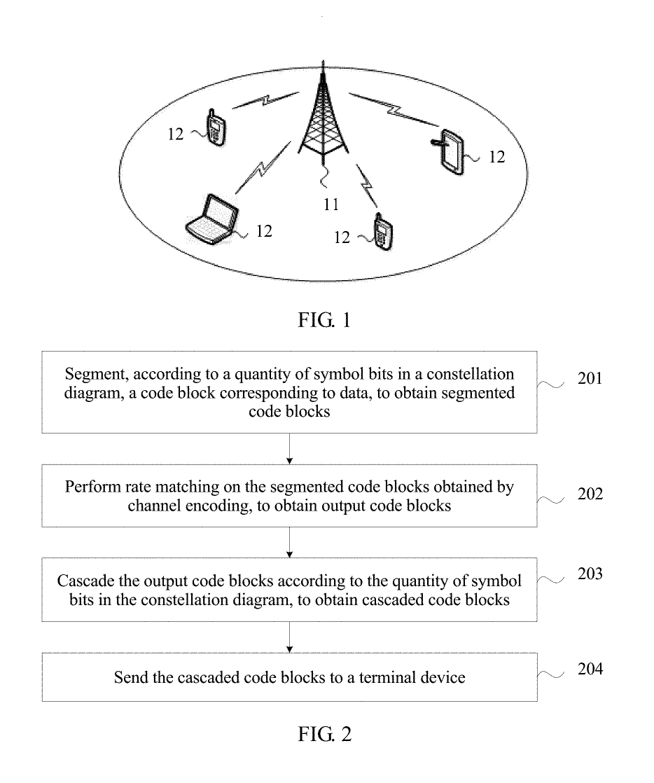

FIG. 1 is a schematic architecture diagram of an application scenario of a data transmission method based on unequal error protection according to the present invention. As shown in FIG. 1, the data transmission method based on unequal error protection is applied to an LTE mobile communications system, and is specifically applied to various video services in the LTE mobile communications system. The system includes a base station 11 and a terminal device 12. The base station 11 is mainly configured to transmit downlink data over a physical downlink shared channel (Physical Downlink Shared Channel, PDSCH for short). The terminal device 12 includes a mobile phone, an intelligent terminal, a multimedia device, a streaming media device, or the like, and is responsible for decoding a received encoding signal, so as to obtain a reconstructed signal that matches the encoding signal.

Detailed descriptions are provided below with reference to several embodiments.

FIG. 2 is a schematic flowchart of Embodiment 1 of a data transmission method based on unequal error protection according to the present invention. This embodiment of the present invention provides a data transmission method based on unequal error protection. The method may be executed by any apparatus that executes the data transmission method based on unequal error protection, and the apparatus may be implemented by using software and/or hardware. In this embodiment, the apparatus may be integrated into a base station.

On the basis of the foregoing system architecture shown in FIG. 1, as shown in FIG. 2, the method in this embodiment may include the following steps.

Step 201: Segment, according to a quantity of symbol bits in a constellation diagram, a code block corresponding to data, to obtain segmented code blocks.

In this embodiment, when the base station receives a message that is sent by a terminal device and that is used to request to receive video data, the base station packs SVC video source data in a unit of byte, that is, performs related processing in a format of a Media Access Control (Media Access Control, MAC for short) protocol data unit (Protocol Data Unit, PDU for short). In a specific implementation process, an L-bit parity bit is first added to a tail of the MAC PDU, to verify whether the MAC PDU is correct. For example, a CRC check manner may be used. A 24-bit parity bit is added to the tail of the MAC PDU. After the parity bit is added, if a length of the MAC PDU is greater than a maximum value 6144 of a code block size, a segment quantity needs to be determined according to the quantity of symbol bits in the constellation diagram, the code block corresponding to the data is segmented according to the segment quantity, and cyclic redundancy check (Cyclic Redundancy Check, CRC for short) redundancy is added to each segmented code block.

Step 202: Perform rate matching on the segmented code blocks obtained by channel encoding, to obtain output code blocks.

In this embodiment, the base station segments the code block, and encodes the segmented code blocks after obtaining the segmented code blocks. In an LTE system, a Turbo encoding manner is usually used. After encoding is performed, system bit code blocks in one channel and parity bit code blocks in two channels are obtained, and interleaving and bit collection processing are separately performed on the code blocks in three channels by using a sub-interleaver, so as to combine the code blocks in three channels into code blocks in one channel. Then, rate matching is performed on the code blocks in one channel to obtain the output code blocks.

Step 203: Cascade the output code blocks according to the quantity of symbol bits in the constellation diagram, to obtain cascaded code blocks.

In this embodiment, the obtained output code blocks are concatenated according to the quantity of symbol bits in the constellation diagram, so that the code blocks are cascaded to obtain the cascaded code blocks.

Step 204: Send the cascaded code blocks to a terminal device.

In this embodiment, the base station sends the cascaded code blocks to the terminal device, so that the terminal device performs code block splitting and decoding processing on the cascaded code blocks to obtain a MAC PDU data packet.

According to the data transmission method based on unequal error protection provided in this embodiment of the present invention, the code block corresponding to the data is segmented according to the quantity of symbol bits in the constellation diagram to obtain the segmented code blocks, rate matching is performed on the segmented code blocks obtained by channel encoding to obtain the output code blocks, the output code blocks are cascaded according to the quantity of symbol bits in the constellation diagram to obtain the cascaded code blocks, and the cascaded code blocks are sent to the terminal device. The base station performs segmentation and cascading processing on the code block according to the quantity of symbol bits in the constellation diagram, so that important data in the data is mapped to a location with a lower bit error rate in the constellation diagram. In this way, a purpose of unequal error protection for data can also be achieved in the LTE system.

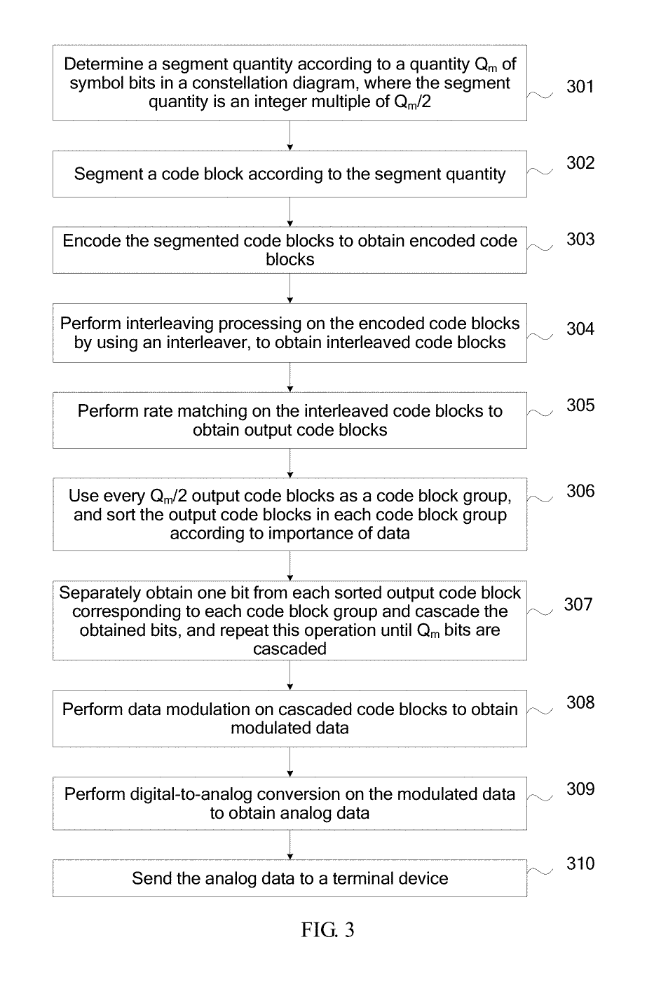

FIG. 3 is a schematic flowchart of Embodiment 2 of a data transmission method based on unequal error protection according to the present invention. On the basis of the embodiment shown in FIG. 2, in this embodiment, manners for segmenting the code block and cascading the output code blocks are described in detail.

On the basis of the foregoing system architecture shown in FIG. 1, as shown in FIG. 3, the method in this embodiment may include the following steps.

Step 301: Determine a segment quantity according to the quantity Qₘ of symbol bits in the constellation diagram, where the segment quantity is an integer multiple of Qₘ/2.

In this embodiment, the segment quantity C is determined according to a formula

$${C}^{′} = \frac{{Q}_{m}}{2} * ⌈ \frac{B}{( Z - L ) * {Q}_{m} / 2} ⌉ .$$

Z represents a maximum value of a code block size and is generally 6144. B represents a magnitude of an input bit stream corresponding to the code block. L represents a magnitude of a CRC parity bit. ┌●┐ represents rounding up; for example, if a calculated value is 3.5, a result of rounding up is 4. The segment quantity C determined according to the foregoing formula is an integer multiple of Qₘ/2. The quantity Qₘ of symbol bits in the constellation diagram is determined according to a modulation manner selected by an MCS. For example, during 16 quadrature amplitude modulation (Quadrature Amplitude Modulation, QAM for short), Qₘ is 4; during 64QAM, Qₘ is 6; and during 256QAM, Qₘ is 8.

Step 302: Segment the code block according to the segment quantity.

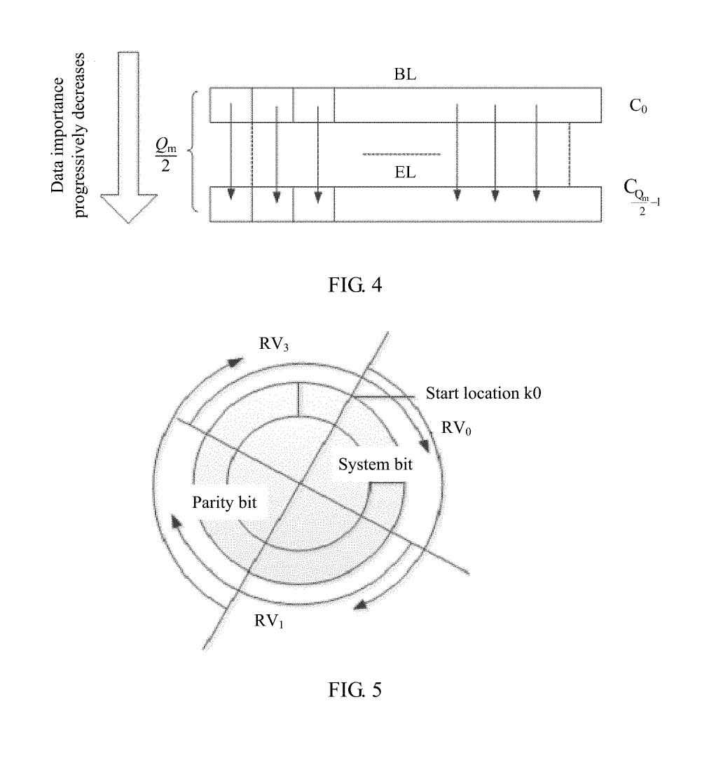

In this embodiment, after the segment quantity is determined, the code block corresponding to the data is segmented according to the segment quantity. By using a manner for determining the segment quantity according to the quantity Qₘ of symbol bits in the constellation diagram and segmenting the code block according to the segment quantity, it may be ensured that important data in the code block is mapped to a location of an MSB in the constellation diagram, and unimportant data is mapped to a location of an LSB in the constellation diagram, so that unequal error protection can be performed according to importance of the data. FIG. 4 is a schematic diagram of a result of code block segmentation. As shown in FIG. 4, an SVC encodes a video sequence into a data stream that includes multiple interdependent layers. In an actual video service system, a corresponding quantity of sublayers (sub code streams) are extracted from the stream according to a specific requirement of a user. The most important layer is a base layer (Base layer, BL for short), and other layers are enhancement layers (Enhancement layers, ELs (1 to N)). All ELs need to rely on BL decoding, and a higher EL needs to rely on a lower EL. Therefore, importance of the BL is higher than that of the EL, and importance of a lower EL is higher than that of a higher EL. Generally, for each code block, when the code block is segmented, important data is arranged in a code block with a forward location, and less important data is arranged in a code block with a backward location.

It should be noted that when a quantity of code blocks is greater than 3, the code blocks need to be rearranged. In a specific implementation process, if there are n*Qₘ/2 blocks, the first n*Qₘ/6 blocks are separately arranged at (1+k*Qₘ/2) the middle n*Qₘ/6 blocks are separately arranged at (2+k*Qₘ/2), and the last n*Qₘ/6 blocks are separately arranged at (3+k*Qₘ/2), where n and k are both integers greater than or equal to zero.

Step 303: Encode the segmented code blocks to obtain encoded code blocks.

In this embodiment, Turbo encoding is performed on the segmented code blocks. Turbo mainly includes parallel cascading convolutional codes, two 8-state sub-encoders, and one Turbo inner-code interleaver. Therefore, a result of Turbo encoding is divided into three channels: The first channel includes system bits, and the last two channels include parity bits. When encoding starts, an initial value of a shift register of the 8-state sub-encoder is 0.

A primary function of the Turbo inner-code interleaver is to combine two mutually independent short codes into one long random code based on an idea of randomization, because performance of a long code can approach the Shannon limit. In addition, the interleaver may be configured to disperse a burst error, and the interleaver may be further configured to break a low-weight input sequence mode, so as to increase a minimum Hamming distance of an output code word or decrease a quantity of low-weight output code words.

Step 304: Perform interleaving processing on the encoded code blocks by using an interleaver, to obtain interleaved code blocks.

In this embodiment, it is assumed that a bit stream that is input into the interleaver is d₀⁽ⁱ⁾, d₁⁽ⁱ⁾, d₂⁽ⁱ⁾, . . . , d_{D-1}⁽ⁱ⁾, where D is a quantity of input bits. A quantity of columns of a matrix in the interleaver is C_{subblock}^{TC}=32, and numbers from left to right are successively 0, 1, 2, . . . , C_{subblock}^{TC}−1. In addition, to avoid a mistake and improve interleaving correctness, a size of the matrix is required to be greater than or equal to D, that is, D≤(R_{subblock}^{TC}×C_{subblock}^{TC}), where R_{subblock}^{TC} is a quantity of rows of the matrix. Therefore, a value of R_{subblock}^{TC} is a minimum integer value of D≤(R_{subblock}^{TC}×C_{subblock}^{TC}), and numbers of the rows of the matrix from top to bottom are successively 0, 1, 2, . . . , R_{subblock}^{TC}−1.

Because D≤(R_{subblock}^{TC}×C_{subblock}^{TC}), the matrix needs to include some padding bits, so as to perform bit padding. Therefore, the matrix includes an information bit and a padding bit. The information bit is a bit corresponding to the data. If (R_{subblock}^{TC}×C_{subblock}^{TC})>D, N_{D}=(R_{subblock}^{TC}×C_{subblock}^{TC}−D) dummy bits need to be added to the matrix.

In this embodiment, entering the interleaver in a row-in manner is described. A column-in manner is similar to this, and details are not described herein again. After a quantity of padding bits is determined, a bit sequence y_{N}_{_{D}}₊ₖ=dₖ⁽ⁱ⁾ is input into the matrix row by row, where k=0, 1, . . . , D−1. The first N_{D}−1 items in the matrix are added padding bits, and a specific form is as follows:

$$[ \begin{matrix}{y}_{0} & {y}_{1} & {y}_{2} & … & {y}_{{C}_{subblock}^{TC} - 1} \\ {y}_{{C}_{subblock}^{TC}} & {y}_{{C}_{subblock}^{TC} + 1} & {y}_{{C}_{subblock}^{TC} + 2} & … & {y}_{2 {C}_{subblock}^{TC} - 1} \\ ⋮ & ⋮ & ⋮ & ⋱ & ⋮ \\ {y}_{( {R}_{subblock}^{TC} - 1 ) \times {C}_{subblock}^{TC}} & {y}_{( {R}_{subblock}^{TC} - 1 ) \times {C}_{subblock}^{TC} + 1} & {y}_{( {R}_{subblock}^{TC} - 1 ) \times {C}_{subblock}^{TC} + 2} & … & {y}_{( {R}_{subblock}^{TC} \times {C}_{subblock}^{TC} - 1 )}\end{matrix} ]$$

Because the result obtained after encoding processing includes data in three channels, correspondingly, three interleavers are required to separately perform interleaving processing on the data in three channels. After the interleaver is entered in the foregoing matrix manner, the three interleavers separately perform corresponding processing on the input matrix.

Specifically, for the system bits in the first channel, an interleaving manner is column permutation. Table 1 shows a column permutation form.

TABLE 1

| Quantity of columns | Column transformation style |
|---|---|
| C_{subblock}^{TC} | <P(0), P(1), . . . , P(C_{subblock}^{TC} − 1)> |
| 32 | <0, 16, 8, 24, 4, 20, 12, 28, 2, 18, 10, |
| | 26, 6, 22, 14, 30, 1, 17, 9, 25, 5, 21, |
| | 13, 29, 3, 19, 11, 27, 7, 23, 15, 31> |

As shown in Table 1, P(j) and a number in the second row and the second column in Table 1 are in a one-to-one correspondence. For example, an original first column is permutated into a sixteenth column, and an original second column is permutated into an eighth column. A transformed matrix is:

$$[ \begin{matrix}{y}_{P ( 0 )} & {y}_{P ( 1 )} & {y}_{P ( 2 )} & … & {y}_{P ( {C}_{subblock}^{TC} - 1 )} \\ {y}_{P ( 0 ) + {C}_{subblock}^{TC}} & {y}_{P ( 1 ) + {C}_{subblock}^{TC}} & {y}_{P ( 2 ) + {C}_{subblock}^{TC}} & … & {y}_{P ( {C}_{subblock}^{TC} - 1 ) + {C}_{subblock}^{TC}} \\ ⋮ & ⋮ & ⋮ & ⋱ & ⋮ \\ {y}_{P ( 0 ) + ( {R}_{subblock}^{TC} - 1 ) \times {C}_{subblock}^{TC}} & {y}_{P ( 1 ) + ( {R}_{subblock}^{TC} - 1 ) \times {C}_{subblock}^{TC}} & {y}_{P ( 2 ) ( {R}_{subblock}^{TC} - 1 ) \times {C}_{subblock}^{TC}} & … & {y}_{P ( {C}_{subblock}^{TC} - 1 ) + ( {R}_{subblock}^{TC} - 1 ) \times {C}_{subblock}^{TC}}\end{matrix} ]$$

P(j) represents an original column location of j^{th} transformed column. For example, y_{P(1)} in a permutated matrix is corresponding to a bit of y₁₆ in the original matrix.

For the parity bits in the second channel, an interleaving manner is a row-in-column-out manner, that is, a bit sequence is read column by column.

For the parity bits in the second channel, output bits may be expressed as v₀⁽²⁾, v₁⁽²⁾, v₂⁽²⁾, . . . , v_{K}_{_{Π}}₋₁⁽²⁾. vₖ⁽²⁾=y_{π}^{(k)}, where k is an integer greater than or equal to zero, and π(k) and K_{Π} may be calculated according to the following formula:

$$\begin{matrix}π ( k ) = ( P ( ⌊ \frac{k}{{R}_{subblock}^{TC}} ⌋ ) + {C}_{subblock}^{TC} \times ( k mod {R}_{subblock}^{TC} ) + 1 ) mod {K}_{\prod } & ( 1 ) \\ {K}_{\prod } = ( {R}_{subblock}^{TC} \times {C}_{subblock}^{TC} ) & ( 2 )\end{matrix}$$

Step 305: Perform rate matching on the interleaved code blocks to obtain the output code blocks.

In this embodiment, rate matching is performed in a unit of code block. In this case, it is assumed that an input sequence is wᵣ₀ wᵣ₁ . . . w_{r(3Tr-1)}. A buffer size N_{IR} of a single process and a single stream is first calculated according to the following formula:

$${N}_{IR} = ⌊ \frac{{N}_{soft}}{{K}_{MIMO} \cdot min ( {M}_{DL \_ HARQ} , {M}_{limit} )} ⌋ \qquad ( 3 )$$

└●┘ represents rounding down; N_{soft} is maximum data cache that can be processed by UE; K_{MIMO} is determined by a quantity of streams and a value is 1 or 2; M_{DL}_{_}_{HARQ} is a maximum quantity of downlink hybrid automatic repeat request (Hybrid Automatic Repeat reQuest, HARQ for short) processes; Mₗᵢₘᵢₜ represents a constant whose value is 8; min(M_{DL}_{_}_{HARQ},Mₗᵢₘᵢₜ) is a quantity of HARQ processes.

Then, a buffer size N_{cb} of each code block is calculated according to a formula (4):

$${N}_{cb} = min ( ⌊ \frac{{N}_{IR}}{C} ⌋ , {K}_{w} ) \qquad ( 4 )$$

C is a quantity of code blocks, and K_{w} is a total magnitude of a bit stream from three sub-interleavers.

After the buffer size of each code block is calculated, an output length Eᵣ of each code block after rate matching is performed is calculated according to a formula (5):

$${E}_{r} = \{ \begin{matrix}{N}_{L} \cdot {Q}_{m} \cdot ⌊ {G}^{′} / C ⌋ , r \leq C - γ - 1 \\ {N}_{L} \cdot {Q}_{m} \cdot ⌈ {G}^{′} / C ⌉ , r > C - γ - 1\end{matrix} \qquad ( 5 )$$

γ=G′ mod C, G′=G/(N_{L}·Qₘ), r is an integer from 0 to C−1, and G is a total quantity of bits that can be transmitted according to an allocated available RB resource.

FIG. 5 shows a rate matching process in an LTE network. As shown in FIG. 5, it is assumed that a buffer size of an r^{th} code block is N_{cb}, and an output length of rate matching is Eᵣ. A version Rv₀ is sent for a first time. If a receive end does not perform decoding correctly, an Rv_{id} version is replaced, until the receive end performs decoding correctly.

It should be noted that because a padding bit is padded into the matrix during interleaving processing, when rate matching is performed, if a padding bit is detected, the padding bit is directly skipped, and a next bit is matched. In this way, rate matching is not performed on the padding bit, and bandwidth is effectively saved.

Step 306: Use every Qₘ/2 output code blocks as a code block group, and sort the output code blocks in each code block group according to importance of the data.

In this embodiment, to ensure that a bit is mapped to a corresponding location of each constellation symbol according to importance of the data, every Qₘ/2 output code blocks are used as a code block group, and data with progressively decreasing importance is separately placed into one code block group.

Step 307: Separately obtain one bit from each sorted output code block corresponding to each code block group and cascade the obtained bits, and repeat this operation until Qₘ bits are cascaded.

In this embodiment, when the code blocks are cascaded, a code block group is used as a unit; and for each code block group, the sorted output code blocks are scanned, and one bit is obtained from each output code block. In this way, each time bit selection is performed, Qₘ/2 code blocks can be obtained. Because every Qₘ bits are corresponding to a symbol in the constellation diagram, selection needs to be consecutively performed twice to obtain Qₘ bits. After selection is performed on a code block group, selection is performed on a following code block group. After the bits in each code block are obtained in this manner, when constellation mapping is performed, different data is mapped to a corresponding location according to importance of the data.

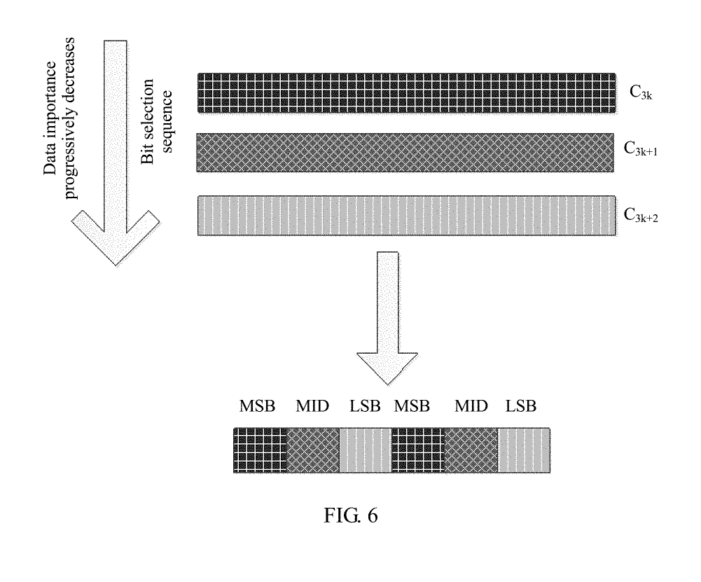

64QAM is used as an example for description. FIG. 6 is a schematic diagram of a code block cascading process. As shown in FIG. 6, when the code block is segmented, according to calculation, a quantity of code blocks is set to be a multiple of 3. Data in a code block C₃ₖ is more important than data in a code block C₃ₖ₊₁, data in C₃ₖ₊₁ is more important than data in C₃ₖ₊₂, and C₃ₖ, C₃ₖ₊₁, and C₃ₖ₊₂ (k is an integer) form a code block group. When the code blocks are cascaded, one bit is selected from C₃ₖ, C₃ₖ₊₁ and C₃ₖ₊₂ (k is an integer) sequentially. When selection is performed twice, one 64QAM symbol is formed. In this way, the selected bits are sequentially mapped to corresponding locations of MSBs, middle bits (Middle bites, MIDs for short), and LSBs in the 64QAM symbol.

Step 308: Perform data modulation on the cascaded code blocks to obtain modulated data.

Step 309: Perform digital-to-analog conversion on the modulated data to obtain analog data.

Step 310: Send the analog data to the terminal device.

According to the data transmission method based on unequal error protection provided in this embodiment of the present invention, the code block corresponding to the data is segmented according to the quantity of symbol bits in the constellation diagram to obtain the segmented code blocks, rate matching is performed on the segmented code blocks obtained by channel encoding to obtain the output code blocks, the output code blocks are cascaded according to the quantity of symbol bits in the constellation diagram to obtain the cascaded code blocks, and the cascaded code blocks are sent to the terminal device. The base station performs segmentation and cascading processing on the code block according to the quantity of symbol bits in the constellation diagram, so that important data in the data is mapped to a location with a lower bit error rate in the constellation diagram. In this way, a purpose of unequal error protection for data can also be achieved in the LTE system. In addition, importance of video data is distinguished according to a code block, so that operability is improved.

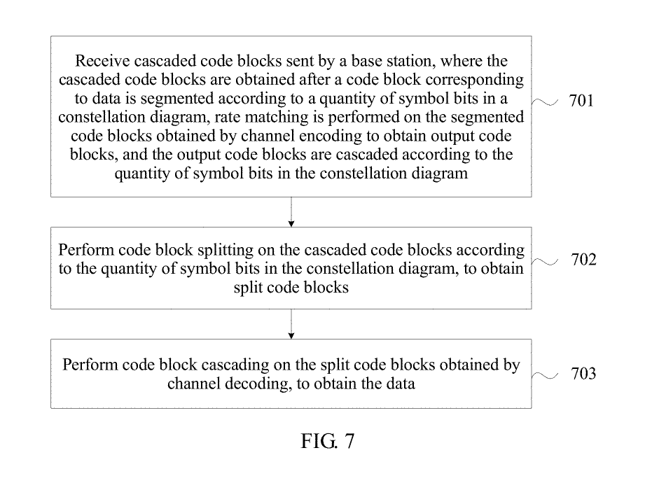

FIG. 7 is a schematic flowchart of Embodiment 3 of a data transmission method based on unequal error protection according to the present invention. This embodiment of the present invention provides a data transmission method based on unequal error protection. The method may be executed by any apparatus that executes the data transmission method based on unequal error protection, and the apparatus may be implemented by using software and/or hardware. In this embodiment, the apparatus may be integrated into a terminal device.

On the basis of the foregoing system architecture shown in FIG. 1, as shown in FIG. 7, the method in this embodiment may include the following steps.

Step 701: Receive cascaded code blocks sent by a base station, where the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram.

In this embodiment, when the base station receives a message that is sent by the terminal device and that is used to request to receive data, the base station packs SVC video source data in a unit of byte, that is, performs related processing in a format of a Media Access Control (Media Access Control, MAC for short) protocol data unit (Protocol Data Unit, PDU for short). In a specific implementation process, an L-bit parity bit is first added to a tail of the MAC PDU, to verify whether the MAC PDU is correct. For example, a CRC check manner may be used. A 24-bit parity bit is added to the tail of the MAC PDU. After the parity bit is added, if a length of the MAC PDU is greater than a maximum value 6144 of the code block, a segment quantity needs to be determined according to the quantity of symbol bits in the constellation diagram, the code block corresponding to the data is segmented according to the segment quantity, and cyclic redundancy check (Cyclic Redundancy Check, CRC for short) redundancy is added to each segmented code block.

The base station segments the code block, and encodes the segmented code blocks after obtaining the segmented code blocks. In an LTE system, a Turbo encoding manner is usually used. After encoding is performed, system bit code blocks in one channel and parity bit code blocks in two channels are obtained, and interleaving and bit collection processing are separately performed on the code blocks in three channels by using a sub-interleaver, so as to combine the code blocks in three channels into code blocks in one channel. Then, rate matching is performed on the code blocks in one channel to obtain the output code blocks. The base station concatenates the obtained output code blocks according to the quantity of symbol bits in the constellation diagram, so as to cascade the code blocks to obtain the cascaded code blocks, and sends the cascaded code blocks to the terminal device.

Step 702: Perform code block splitting on the cascaded code blocks according to the quantity of symbol bits in the constellation diagram, to obtain split code blocks.

In this embodiment, the base station performs code block cascading according to the quantity of symbol bits in the constellation diagram. Correspondingly, after receiving the cascaded code blocks sent by the base station, the terminal device needs to perform code block splitting according to the quantity of symbol bits in the constellation diagram, to obtain the split code block.

Step 703: Perform code block cascading on the split code blocks obtained by channel decoding, to obtain the data.

In this embodiment, when cascading the decoded split code blocks, the terminal device sequentially concatenates all code blocks, to obtain an output sequence bit, that is, obtain a MAC PDU data packet.

According to the data transmission method based on unequal error protection provided in this embodiment of the present invention, the base station segments, according to the quantity of symbol bits in the constellation diagram, the code block corresponding to the data to obtain the segmented code blocks, performs rate matching on the segmented code blocks obtained by channel encoding to obtain the output code blocks, cascades the output code blocks according to the quantity of symbol bits in the constellation diagram to obtain the cascaded code blocks, and sends the cascaded code blocks to the terminal device. The base station performs segmentation and cascading processing on the code block according to the quantity of symbol bits in the constellation diagram, so that important data in the data is mapped to a location with a lower bit error rate in the constellation diagram. In this way, a purpose of unequal error protection for data can also be achieved in the LTE system. In addition, the terminal device performs code block splitting on the cascaded code blocks according to the quantity of symbol bits in the constellation diagram, to obtain data whose arrangement sequence is the same as that of original data, so that unequal error protection for video data is implemented.

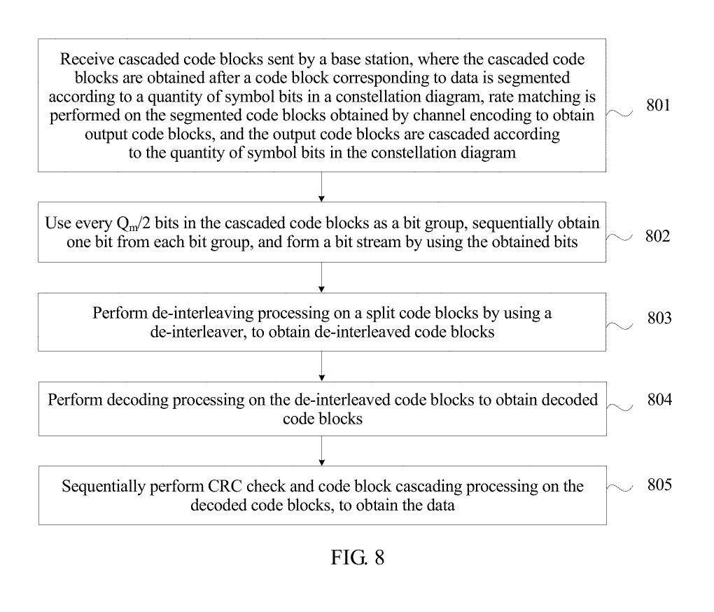

FIG. 8 is a schematic flowchart of Embodiment 4 of a data transmission method based on unequal error protection according to the present invention. On the basis of the embodiment shown in FIG. 7, in this embodiment, a manner for performing code block splitting on the cascaded code blocks is described in detail.

On the basis of the foregoing system architecture shown in FIG. 1, as shown in FIG. 8, the method in this embodiment may include the following steps.

Step 801: Receive the cascaded code blocks sent by the base station, where the cascaded code blocks are obtained after the code block corresponding to the data is segmented according to the quantity of symbol bits in the constellation diagram, rate matching is performed on the segmented code blocks obtained by channel encoding to obtain the output code blocks, and the output code blocks are cascaded according to the quantity of symbol bits in the constellation diagram.

Step 802: Use every Qₘ/2 bits in the cascaded code blocks as a bit group, sequentially obtain one bit from each bit group, and form a bit stream by using the obtained bits.

In this embodiment, step 802 is an inverse operation of step 306 and step 307. Specifically, received 64QAM symbols are arranged vertically. A second symbol is connected to a previous symbol after being arranged vertically, the rest are arranged sequentially, and finally code blocks are formed by row for outputting. In this way, code block splitting is completed, and data that is on the base station side and that is mapped to a corresponding location in the constellation diagram according to data importance is restored.

Step 803: Perform de-interleaving processing on the split code blocks by using a de-interleaver, to obtain de-interleaved code blocks.

Step 803 is an inverse operation of step 304.

Step 804: Perform decoding processing on the de-interleaved code blocks to obtain decoded code blocks.

Step 804 is an inverse operation of step 303.

Step 805: Sequentially perform CRC check and code block cascading processing on the decoded code blocks, to obtain the data.

In this embodiment, when the code blocks after CRC check are cascaded, the code blocks are sequentially concatenated, to obtain the MAC PDU data packet.

According to the data transmission method based on unequal error protection provided in this embodiment of the present invention, the base station performs segmentation and cascading processing on the code block according to the quantity of symbol bits in the constellation diagram, so that important data in the data is mapped to a location with a lower bit error rate in the constellation diagram. In this way, a purpose of unequal error protection for data can also be achieved in the LTE system. In addition, the terminal device performs, according to the quantity of symbol bits in the constellation diagram, code block splitting on the cascaded code blocks sent by the base station, and performs code block cascading on the obtained split code block. Code blocks mapped to different locations can be split, data is obtained, and scalability of a communications system is improved.

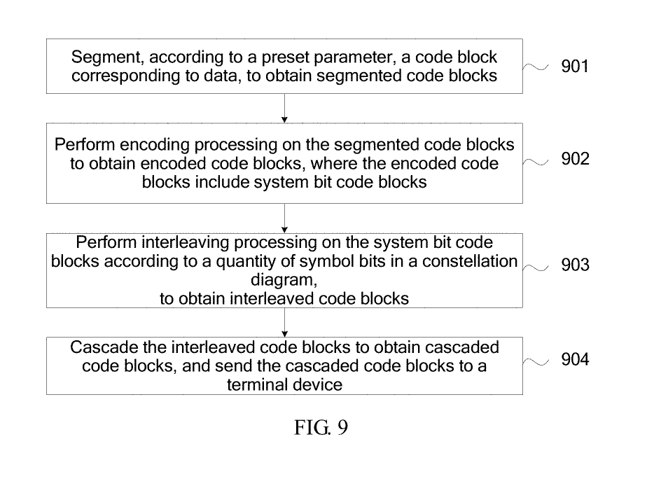

FIG. 9 is a schematic flowchart of Embodiment 5 of a data transmission method based on unequal error protection according to the present invention. This embodiment of the present invention provides a data transmission method based on unequal error protection. The method may be executed by any apparatus that executes the data transmission method based on unequal error protection, and the apparatus may be implemented by using software and/or hardware. In this embodiment, the apparatus may be integrated into a base station.

On the basis of the foregoing system architecture shown in FIG. 1, as shown in FIG. 9, the method in this embodiment may include the following steps.

Step 901: Segment, according to a preset parameter, a code block corresponding to data, to obtain segmented code blocks.

In this embodiment, in 16QAM, a value of Qₘ/2 is 2; or in 256QAM, a value of Qₘ/2 is 4. Because a bit stream length Dᵣ that is input into a sub-interleaver is required to be an integer multiple of 2 or 4, when the code block is output from a Turbo encoder, four tail bits need to be added to bits in each channel. That is, Dᵣ=Kᵣ+4, where Kᵣ represents a length of an r^{th} code block when the code block is input into the Turbo encoder, and Dᵣ represents a length of the r^{th} code block when the code block is output from the Turbo encoder. According to an existing protocol, a length of a Turbo code block meets this condition; therefore, a parameter calculation method for code block segmentation is the same as that in the prior art.

However, in 64QAM, to ensure that a sequence of mapping to MSBs, MIDs, and LSBs on a constellation symbol is not affected after the sub-interleaver performs column permutation on the code block, a code block length is required to meet a condition that (Kᵣ+4)mod 3=0. Therefore, a segment quantity needs to be determined according to the preset parameter, and the code block corresponding to the data is segmented.

Step 902: Perform encoding processing on the segmented code blocks to obtain encoded code blocks, where the encoded code blocks include system bit code blocks.

Step 902 is similar to step 303, and details are not described herein again.

Step 903: Perform interleaving processing on the system bit code blocks according to a quantity of symbol bits in a constellation diagram, to obtain interleaved code blocks.

In this embodiment, after encoding processing is performed on the segmented code blocks, system bit code blocks and parity bit code blocks in two channels are obtained. For an interleaving processing manner corresponding to the parity bit code blocks in two channels, refer to step 304, and details are not described herein again.

The system bit code blocks may be processed according to the quantity of symbol bits in the constellation diagram, to obtain the interleaved code blocks.

Step 904: Cascade the interleaved code blocks to obtain cascaded code blocks, and send the cascaded code blocks to a terminal device.

In this embodiment, the obtained interleaved code blocks are sequentially concatenated to obtain the cascaded code blocks; data modulation and digital-to-analog conversion are sequentially performed on the cascaded code blocks to obtain analog data; and the analog data is sent to the terminal device, so that the terminal device performs decoding to obtain the data.

According to the data transmission method based on unequal error protection provided in this embodiment of the present invention, the code block corresponding to video data is segmented according to the preset parameter to obtain the segmented code blocks; encoding processing is performed on the segmented code blocks to obtain the encoded code blocks, where the encoded code blocks include the system bit code blocks; interleaving processing is performed on the system bit code blocks according to the quantity of symbol bits in the constellation diagram to obtain the interleaved code blocks; and the interleaved code blocks are cascaded to obtain the cascaded code blocks, and the cascaded code blocks are sent to the terminal device. The base station performs interleaving processing on the system bit code blocks according to the quantity of symbol bits in the constellation diagram, so that important data in the data is mapped to a location with a lower bit error rate in the constellation diagram. In this way, a purpose of unequal error protection for data can also be achieved in an LTE system.

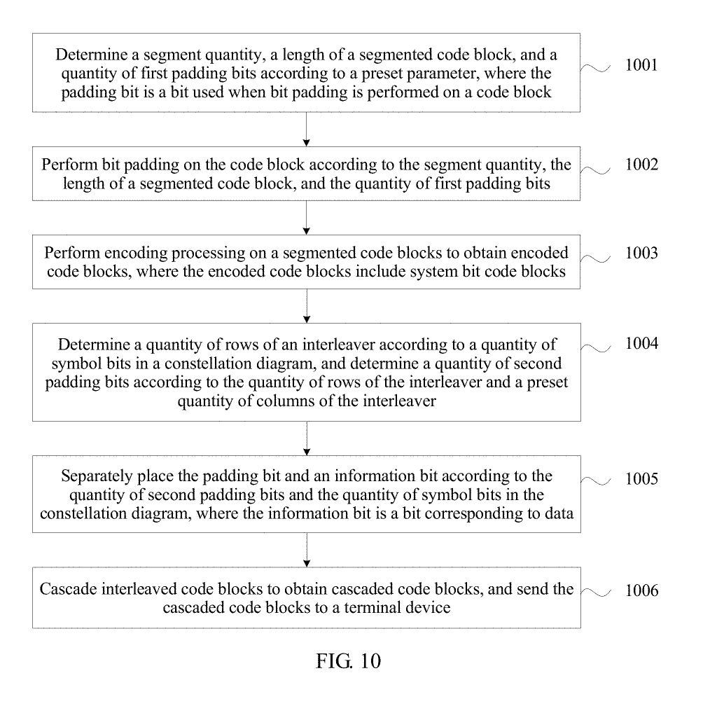

FIG. 10 is a schematic flowchart of Embodiment 6 of a data transmission method based on unequal error protection according to the present invention. On the basis of the embodiment shown in FIG. 9, in this embodiment, manners for segmenting the code block and performing interleaving processing on the system bit code blocks are described in detail.

On the basis of the foregoing system architecture shown in FIG. 1, as shown in FIG. 10, the method in this embodiment may include the following steps.

Step 1001: Determine a segment quantity, a length of a segmented code block, and a quantity of first padding bits according to the preset parameter, where the padding bit is a bit used when bit padding is performed on the code block.

In this embodiment, in 64QAM, the code block length is required to meet the condition that (Kᵣ+4)mod 3=0. Therefore, a Kᵣ value that meets this condition in Table 2 needs to be selected to form a new 64QAM code block length table. Table 2 shows an original code block segment length and some Turbo inner-code interleaver parameters, and Table 3 shows a modified code block segment length and some Turbo inner-code interleaver parameters.

TABLE 2

| i | Kᵢ | f₁ | f₂ |
|---|---|---|---|
| 3 | 56 | 19 | 42 |
| 4 | 80 | 11 | 20 |
| 7 | 104 | 7 | 26 |
| 10 | 128 | 15 | 32 |
| 13 | 152 | 9 | 38 |
| 16 | 176 | 21 | 44 |
| 19 | 200 | 13 | 50 |
| 22 | 224 | 27 | 56 |
| 48 | 416 | 25 | 52 |
| 51 | 440 | 91 | 110 |
| 54 | 464 | 247 | 58 |
| 57 | 488 | 91 | 122 |
| 60 | 512 | 31 | 64 |
| 63 | 560 | 227 | 420 |
| 66 | 608 | 37 | 76 |
| 69 | 656 | 185 | 82 |
| 101 | 1184 | 19 | 74 |
| 106 | 1280 | 199 | 240 |
| 109 | 1376 | 21 | 86 |
| 112 | 1472 | 45 | 92 |
| 115 | 1568 | 13 | 28 |
| 118 | 1664 | 183 | 104 |
| 121 | 1760 | 27 | 110 |
| 124 | 1856 | 57 | 116 |
| 142 | 3200 | 111 | 240 |
| 145 | 3392 | 51 | 212 |
| 148 | 3584 | 57 | 336 |
| 151 | 3776 | 179 | 236 |
| 154 | 3968 | 375 | 248 |
| 157 | 4160 | 33 | 130 |
| 160 | 4352 | 477 | 408 |
| 163 | 4544 | 357 | 142 |

TABLE 3

| i | Kᵢ | f₁ | f₂ |
|---|---|---|---|
| 3 | 56 | 19 | 42 |
| 4 | 80 | 11 | 20 |
| 7 | 104 | 7 | 26 |
| 10 | 128 | 15 | 32 |
| 13 | 152 | 9 | 38 |
| 16 | 176 | 21 | 44 |
| 19 | 200 | 13 | 50 |
| 22 | 224 | 27 | 56 |
| 48 | 416 | 25 | 52 |
| 51 | 440 | 91 | 110 |
| 54 | 464 | 247 | 58 |
| 57 | 488 | 91 | 122 |
| 60 | 512 | 31 | 64 |
| 63 | 560 | 227 | 420 |
| 66 | 608 | 37 | 76 |
| 69 | 656 | 185 | 82 |
| 101 | 1184 | 19 | 74 |
| 106 | 1280 | 199 | 240 |
| 109 | 1376 | 21 | 86 |
| 112 | 1472 | 45 | 92 |
| 115 | 1568 | 13 | 28 |
| 118 | 1664 | 183 | 104 |
| 121 | 1760 | 27 | 110 |
| 124 | 1856 | 57 | 116 |
| 142 | 3200 | 111 | 240 |
| 145 | 3392 | 51 | 212 |
| 148 | 3584 | 57 | 336 |
| 151 | 3776 | 179 | 236 |
| 154 | 3968 | 375 | 248 |
| 157 | 4160 | 33 | 130 |
| 160 | 4352 | 477 | 408 |
| 163 | 4544 | 357 | 142 |

When a total quantity of code blocks and a code block length are calculated, C₊, C₋, K₊, K₋, and F are determined according to an existing method and based on Table 3. K₊ and K₋ represent the code block length; C₊ represents a quantity of code blocks whose code block lengths are K₊; C₋ represents a quantity of code blocks whose code block lengths are K₋; and F is a quantity of padding bits.

Step 1002: Perform bit padding on the code block according to the segment quantity, the length of a segmented code block, and the quantity of first padding bits.

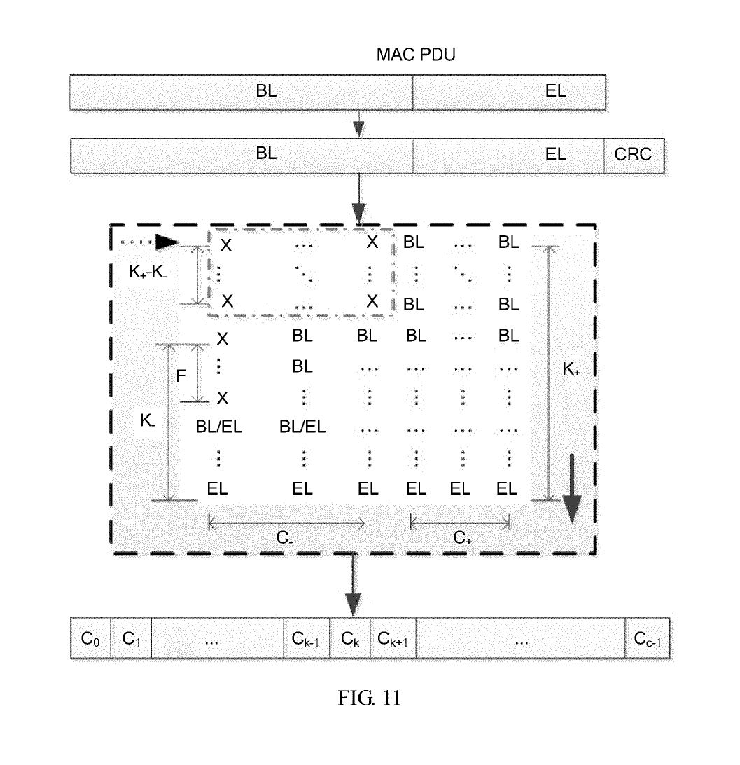

In this embodiment, FIG. 11 is a schematic diagram of segmentation processing. As shown in FIG. 11, after CRC check is performed on a MAC PDU data packet, when segmentation processing is performed, a K₊-row-C-column interleaver is added to a matrix. A padding bit is placed into a sub-matrix of a (K₊-K₋)*C₋ size in an upper left corner of the matrix. F padding bits are then placed into a first column. A MAC PDU sequence is input into the interleaver by column and is output by column. In this way, C code blocks that comply with an arrangement sequence that important data is placed forward are obtained.

Step 1003: Perform encoding processing on the segmented code blocks to obtain the encoded code blocks, where the encoded code blocks include the system bit code blocks.

Step 1004: Determine a quantity of rows of an interleaver according to the quantity of symbol bits in the constellation diagram, and determine a quantity of second padding bits according to the quantity of rows of the interleaver and a preset quantity of columns of the interleaver.

In this embodiment, a quantity of rows of the sub-interleaver is required to be a minimum integer value of R_{subblock}^{TC}*32>D and

$${R}_{subblock}^{TC} mod \frac{{Q}_{m}}{2} = 0 ,$$

where R_{subblock}^{TC} is the quantity of rows of the sub-interleaver, and D is a quantity of input bits. In addition, the quantity of second padding bits N_{D}=R_{subblock}^{TC}*C_{subblock}^{TC}−D, where C_{subblock}^{TC} is a quantity of columns of the interleaver, and a value is generally 32.

Step 1005: Separately place the padding bit and an information bit according to the quantity of second padding bits and the quantity of symbol bits in the constellation diagram, where the information bit is a bit corresponding to the data.

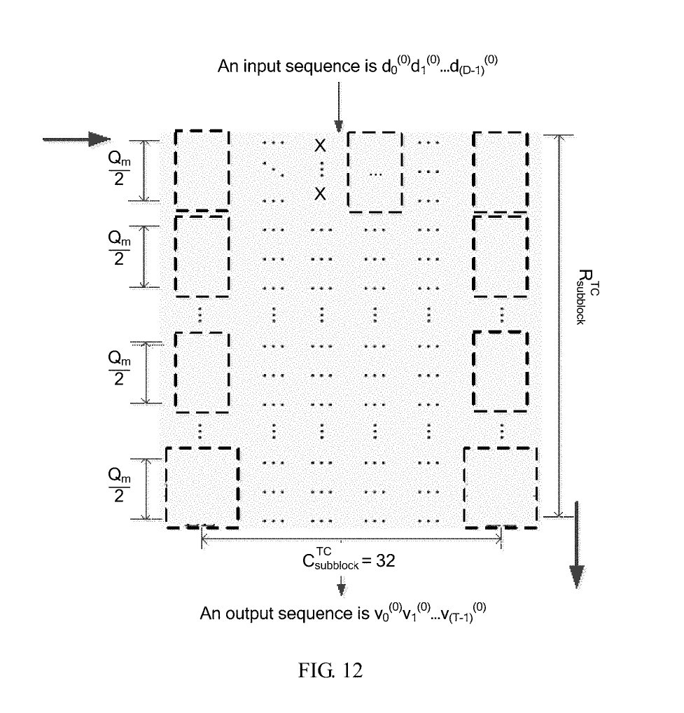

FIG. 12 is a schematic diagram of interleaving processing. As shown in FIG. 12, generally, N_{D}<Qₘ/2*C_{subblock}^{TC}. Therefore, the padding bit X is placed into a sub-matrix of (Qₘ/2)*(2N_{D}/Qₘ) in an upper left corner of a matrix. For placement of the information bit, from a first row, one information bit may be placed every Qₘ/2 rows. After placement is completed, from a second row, the information bit is placed every Qₘ/2 rows. This operation is cyclically performed until placement is performed from a Qₘ/2th row, so that all information bits are placed. It can be learned that code block data is placed every Qₘ/2 rows, so that most important data is placed into a first row of a column of data of Qₘ/2 bits, less important data is placed into a middle row, and least important data is placed into a last row. In this way, although column permutation is performed, after a bit stream is read by column, a group of Qₘ/2 bits can be mapped to corresponding MSBs, MIDs, and LSBs on a constellation symbol.

Step 1006: Cascade the interleaved code blocks to obtain the cascaded code blocks, and send the cascaded code blocks to the terminal device.

According to the data transmission method based on unequal error protection provided in this embodiment of the present invention, the code block corresponding to the data is segmented according to the preset parameter to obtain the segmented code blocks; encoding processing is performed on the segmented code blocks to obtain the encoded code blocks, where the encoded code blocks include the system bit code blocks; interleaving processing is performed on the system bit code blocks according to the quantity of symbol bits in the constellation diagram to obtain the interleaved code blocks; and the interleaved code blocks are cascaded to obtain the cascaded code blocks, and the cascaded code blocks are sent to the terminal device. The base station performs interleaving processing on the system bit code blocks according to the quantity of symbol bits in the constellation diagram, so that important data in the data is mapped to a location with a lower bit error rate in the constellation diagram. In this way, a purpose of unequal error protection for data can also be achieved in the LTE system. In addition, importance of the data is distinguished according to a code block, any modulation manner may be adapted to, and system scalability is improved.

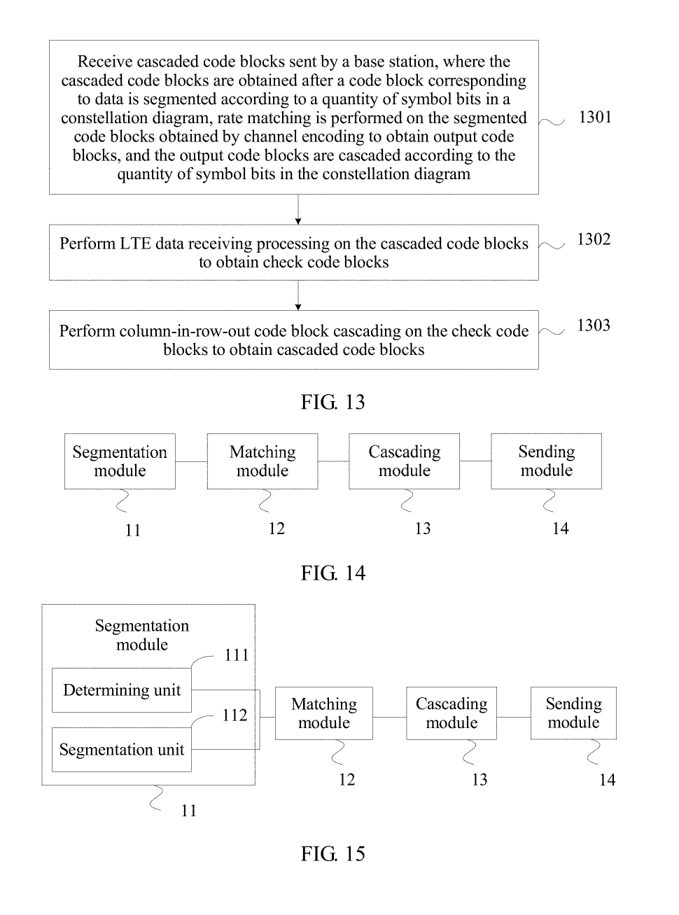

FIG. 13 is a schematic flowchart of Embodiment 7 of a data transmission method based on unequal error protection according to the present invention. This embodiment of the present invention provides a data transmission method based on unequal error protection. The method may be executed by any apparatus that executes the data transmission method based on unequal error protection, and the apparatus may be implemented by using software and/or hardware. In this embodiment, the apparatus may be integrated into a terminal device.

On the basis of the foregoing system architecture shown in FIG. 1, as shown in FIG. 13, the method in this embodiment may include the following steps.

Step 1301: Receive cascaded code blocks sent by a base station, where the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram.

In this embodiment, to ensure, by the base station, that a sequence of mapping to MSBs, MIDs, and LSBs on a constellation symbol is not affected after a sub-interleaver performs column permutation on the code block, a code block length is required to meet a condition that (Kᵣ+4)mod 3=0. Therefore, a segment quantity needs to be determined according to a preset parameter, and the code block corresponding to the data is segmented. After segmenting is completed, the obtained segmented code block is encoded to obtain an encoded code block, where the encoded code blocks include system bit code blocks. Then, interleaving processing is performed on the system bit code blocks according to the quantity of symbol bits in the constellation diagram to obtain interleaved code blocks, the interleaved code blocks are cascaded to obtain the cascaded code blocks, and the cascaded code blocks are sent to the terminal device.

Step 1302: Perform LTE data receiving processing on the cascaded code blocks to obtain check code blocks.

In this embodiment, after the cascaded code blocks sent by the base station are received, code block splitting is performed on the cascaded code block, and de-interleaving processing, decoding processing, and CRC check are sequentially performed on an obtained split code block to obtain the check code blocks.

Step 1303: Perform column-in-row-out code block cascading on the check code blocks to obtain cascaded code blocks.

In this embodiment, the check code blocks are cascaded according to a column-in-row-out principle to form data in a BL+EL form, so that a sequence of cascaded data is consistent with that of original MAC PDU data.

According to the data transmission method based on unequal error protection provided in this embodiment of the present invention, the cascaded code blocks sent by the base station are received, LTE data receiving processing is performed on the cascaded code blocks to obtain the check code blocks, and row-in-column-out code block cascading is performed on the check code blocks to obtain the cascaded code blocks. The base station performs interleaving processing on the system bit code blocks according to the quantity of symbol bits in the constellation diagram, so that important data in the data is mapped to a location with a lower bit error rate in the constellation diagram. In this way, a purpose of unequal error protection for data can also be achieved in an LTE system. In addition, the terminal device performs column-in-row-out code block cascading on the check code block, so that the sequence of the cascaded data is consistent with that of the original MAC PDU data, unequal error protection for video data is implemented, and video quality is improved.

FIG. 14 is a schematic structural diagram of Embodiment 1 of a data transmission apparatus based on unequal error protection according to the present invention. As shown in FIG. 14, the data transmission apparatus based on unequal error protection provided in this embodiment of the present invention includes a segmentation module 11, a matching module 12, a cascading module 13, and a sending module 14.

The segmentation module 11 is configured to segment, according to a quantity of symbol bits in a constellation diagram, a code block corresponding to data, to obtain segmented code blocks. The matching module 12 is configured to perform rate matching on the segmented code blocks obtained by channel encoding, to obtain output code blocks. The cascading module 13 is configured to cascade the output code blocks according to the quantity of symbol bits in the constellation diagram, to obtain cascaded code blocks. The sending module 14 is configured to send the cascaded code blocks to a terminal device.

According to the data transmission apparatus based on unequal error protection provided in this embodiment of the present invention, the code block corresponding to the data is segmented according to the quantity of symbol bits in the constellation diagram to obtain the segmented code blocks, rate matching is performed on the segmented code blocks obtained by channel encoding to obtain the output code blocks, the output code blocks are cascaded according to the quantity of symbol bits in the constellation diagram to obtain the cascaded code blocks, and the cascaded code blocks are sent to the terminal device. A base station performs segmentation and cascading processing on the code block according to the quantity of symbol bits in the constellation diagram, so that important data in the data is mapped to a location with a lower bit error rate in the constellation diagram. In this way, a purpose of unequal error protection for data can also be achieved in an LTE system.

FIG. 15 is a schematic structural diagram of Embodiment 2 of a data transmission apparatus based on unequal error protection according to the present invention. As shown in FIG. 15, on the basis of the embodiment shown in FIG. 14, in this embodiment, the segmentation module 11 includes:

a determining unit 111, configured to determine a segment quantity according to the quantity Qₘ of symbol bits in the constellation diagram, where the segment quantity is an integer multiple of Qₘ/2; and

a segmentation unit 112, configured to segment the code block according to the segment quantity.

Optionally, the determining unit 111 is specifically configured to:

determine the segment quantity C′ according to a formula

$${C}^{′} = \frac{{Q}_{m}}{2} * ⌈ \frac{B}{( Z - L ) * {Q}_{m} / 2} ⌉ ,$$

where Z represents a maximum value of a code block size, B represents a magnitude of an input bit stream corresponding to the code block, and L represents a magnitude of a CRC parity bit.

The data transmission apparatus based on unequal error protection in this embodiment may be configured to execute the technical solution of the data transmission method based on unequal error protection provided in any embodiment of the present invention. An implementation principle and a technical effect of the data transmission apparatus are similar to those of the data transmission method, and details are not described herein again.

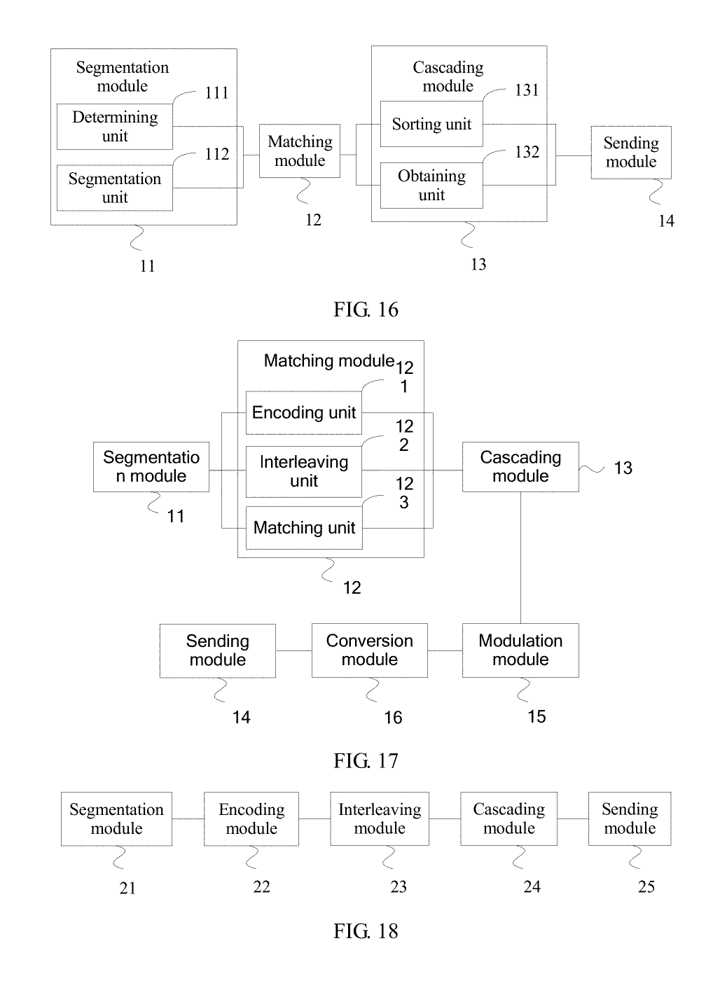

FIG. 16 is a schematic structural diagram of Embodiment 3 of a data transmission apparatus based on unequal error protection according to the present invention. As shown in FIG. 16, on the basis of the embodiment shown in FIG. 15, in this embodiment, the cascading module 13 includes:

a sorting unit 131, configured to use every Qₘ/2 output code blocks as a code block group, and sort the output code blocks in each code block group according to importance of the data; and

an obtaining unit 132, configured to separately obtain one bit from each sorted output code block corresponding to each code block group and cascade the obtained bits, and repeat this operation until Qₘ bits are cascaded.

The data transmission apparatus based on unequal error protection in this embodiment may be configured to execute the technical solution of the data transmission method based on unequal error protection provided in any embodiment of the present invention. An implementation principle and a technical effect of the data transmission apparatus are similar to those of the data transmission method, and details are not described herein again.

FIG. 17 is a schematic structural diagram of Embodiment 4 of a data transmission apparatus based on unequal error protection according to the present invention. As shown in FIG. 17, on the basis of the foregoing embodiments, in this embodiment, the matching module 12 includes:

an encoding unit 121, configured to encode the segmented code blocks to obtain encoded code blocks;

an interleaving unit 122, configured to perform interleaving processing on the encoded code blocks by using an interleaver, to obtain interleaved code blocks;

and a matching unit 123, configured to perform rate matching on the interleaved code blocks to obtain the output code blocks.

Optionally, the apparatus further includes:

a modulation module 15, configured to perform data modulation on the cascaded code blocks to obtain modulated data; and

a conversion module 16, configured to perform digital-to-analog conversion on the modulated data to obtain analog data; where

the sending module 14 is further configured to send the analog data to the terminal device.

The data transmission apparatus based on unequal error protection in this embodiment may be configured to execute the technical solution of the data transmission method based on unequal error protection provided in any embodiment of the present invention. An implementation principle and a technical effect of the data transmission apparatus are similar to those of the data transmission method, and details are not described herein again.

FIG. 18 is a schematic structural diagram of Embodiment 5 of a data transmission apparatus based on unequal error protection according to the present invention. As shown in FIG. 18, the data transmission apparatus based on unequal error protection provided in this embodiment of the present invention includes a segmentation module 21, an encoding module 22, an interleaving module 23, a cascading module 24, and a sending module 25.

The segmentation module 21 is configured to segment, according to a preset parameter, a code block corresponding to data, to obtain segmented code blocks.

The encoding module 22 is configured to perform encoding processing on the segmented code blocks to obtain encoded code blocks, where the encoded code blocks include system bit code blocks.

The interleaving module 23 is configured to perform interleaving processing on the system bit code blocks according to a quantity of symbol bits in a constellation diagram, to obtain interleaved code blocks.

The cascading module 24 is configured to cascade the interleaved code blocks to obtain cascaded code blocks.

The sending module 25 is configured to send the cascaded code blocks to a terminal device.

According to the data transmission apparatus based on unequal error protection provided in this embodiment of the present invention, the code block corresponding to the data is segmented according to the preset parameter to obtain the segmented code blocks; encoding processing is performed on the segmented code blocks to obtain the encoded code blocks, where the encoded code blocks include the system bit code blocks; interleaving processing is performed on the system bit code blocks according to the quantity of symbol bits in the constellation diagram to obtain the interleaved code blocks; and the interleaved code blocks are cascaded to obtain the cascaded code blocks, and the cascaded code blocks are sent to the terminal device. A base station performs interleaving processing on the system bit code blocks according to the quantity of symbol bits in the constellation diagram, so that important data in the data is mapped to a location with a lower bit error rate in the constellation diagram. In this way, a purpose of unequal error protection for data can also be achieved in an LTE system.

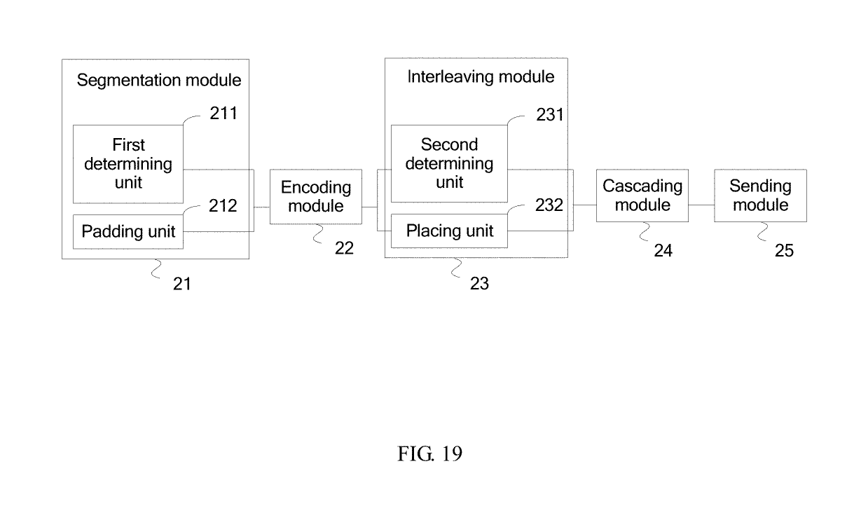

FIG. 19 is a schematic structural diagram of Embodiment 6 of a data transmission apparatus based on unequal error protection according to the present invention. As shown in FIG. 19, on the basis of the embodiment shown in FIG. 18, in this embodiment, the segmentation module 21 includes:

a first determining unit 211, configured to determine a segment quantity, a length of a segmented code block, and a quantity of first padding bits according to the preset parameter, where the padding bit is a bit used when bit padding is performed on the code block; and

a padding unit 212, configured to perform bit padding on the code block according to the segment quantity, the length of a segmented code block, and the quantity of first padding bits, so as to segment the code block.

Optionally, the interleaving module 23 includes:

a second determining unit 231, configured to determine a quantity of rows of an interleaver according to the quantity of symbol bits in the constellation diagram, and determine a quantity of second padding bits according to the quantity of rows of the interleaver and a preset quantity of columns of the interleaver; and

a placing unit 232, configured to separately place the padding bit and an information bit according to the quantity of second padding bits and the quantity of symbol bits in the constellation diagram, where the information bit is a bit corresponding to the data.

The data transmission apparatus based on unequal error protection in this embodiment may be configured to execute the technical solution of the data transmission method based on unequal error protection provided in any embodiment of the present invention. An implementation principle and a technical effect of the data transmission apparatus are similar to those of the data transmission method, and details are not described herein again.

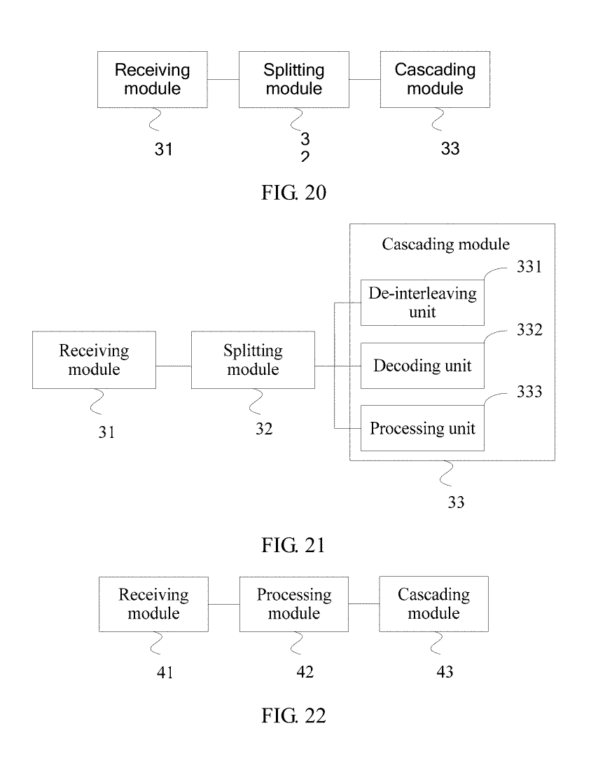

FIG. 20 is a schematic structural diagram of Embodiment 7 of a data transmission apparatus based on unequal error protection according to the present invention. As shown in FIG. 20, the data transmission apparatus based on unequal error protection provided in this embodiment of the present invention includes a receiving module 31, a splitting module 32, and a cascading module 33.

The receiving module 31 is configured to receive cascaded code blocks sent by a base station, where the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram. The splitting module 32 is configured to perform code block splitting on the cascaded code blocks according to the quantity of symbol bits in the constellation diagram, to obtain split code blocks. The cascading module 33 is configured to perform code block cascading on the split code blocks obtained by channel decoding, to obtain the data.

According to the data transmission apparatus based on unequal error protection provided in this embodiment of the present invention, the base station segments, according to the quantity of symbol bits in the constellation diagram, the code block corresponding to the data to obtain the segmented code blocks, performs rate matching on the segmented code blocks obtained by channel encoding to obtain the output code blocks, cascades the output code blocks according to the quantity of symbol bits in the constellation diagram to obtain the cascaded code blocks, and sends the cascaded code blocks to the terminal device. The base station performs segmentation and cascading processing on the code block according to the quantity of symbol bits in the constellation diagram, so that important data in the data is mapped to a location with a lower bit error rate in the constellation diagram. In this way, a purpose of unequal error protection for data can also be achieved in an LTE system. In addition, the terminal device performs code block splitting on the cascaded code blocks according to the quantity of symbol bits in the constellation diagram, to obtain data whose arrangement sequence is the same as that of original data, so that unequal error protection for data is implemented.

Optionally, the splitting module 32 is specifically configured to use every Qₘ/2 bits in the cascaded code blocks as a bit group, sequentially obtain one bit from each bit group, and form a bit stream by using the obtained bits.

FIG. 21 is a schematic structural diagram of Embodiment 8 of a data transmission apparatus based on unequal error protection according to the present invention. As shown in FIG. 21, on the basis of the foregoing embodiments, in this embodiment, the cascading module 33 includes:

a de-interleaving unit 331, configured to perform de-interleaving processing on the split code blocks by using a de-interleaver, to obtain de-interleaved code blocks;

a decoding unit 332, configured to perform decoding processing on the de-interleaved code blocks to obtain decoded code blocks; and

a processing unit 333, configured to sequentially perform CRC check and code block cascading processing on the decoded code blocks, to obtain the data.

The data transmission apparatus based on unequal error protection in this embodiment may be configured to execute the technical solution of the data transmission method based on unequal error protection provided in any embodiment of the present invention. An implementation principle and a technical effect of the data transmission apparatus are similar to those of the data transmission method, and details are not described herein again.

FIG. 22 is a schematic structural diagram of Embodiment 9 of a data transmission apparatus based on unequal error protection according to the present invention. As shown in FIG. 22, the data transmission apparatus based on unequal error protection provided in this embodiment of the present invention includes a receiving module 41, a processing module 42, and a cascading module 43.

The receiving module 41 is configured to receive cascaded code blocks sent by a base station, where the cascaded code blocks are obtained after a code block corresponding to data is segmented according to a preset parameter, encoding processing is performed on the obtained segmented code blocks to obtain encoded code blocks, where the encoded code blocks include system bit code blocks, interleaving processing is performed on the system bit code blocks according to a quantity of symbol bits in a constellation diagram to obtain interleaved code blocks, and the interleaved code blocks are cascaded. The processing module 42 is configured to perform LTE data receiving processing on the cascaded code blocks to obtain check code blocks. The cascading module 43 is configured to perform row-in-column-out code block cascading on the check code blocks to obtain cascaded code blocks.

According to the data transmission apparatus based on unequal error protection provided in this embodiment of the present invention, the cascaded code blocks sent by the base station are received, LTE data receiving processing is performed on the cascaded code blocks to obtain the check code blocks, and row-in-column-out code block cascading is performed on the check code blocks to obtain the cascaded code blocks. The base station performs interleaving processing on the system bit code blocks according to the quantity of symbol bits in the constellation diagram, so that important data in the data is mapped to a location with a lower bit error rate in the constellation diagram. In this way, a purpose of unequal error protection for data can also be achieved in an LTE system.

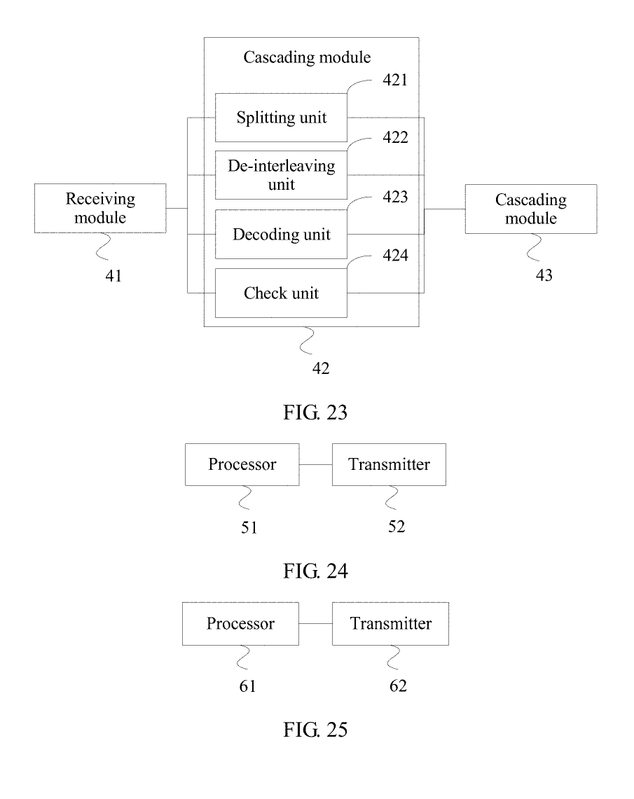

FIG. 23 is a schematic structural diagram of Embodiment 10 of a data transmission apparatus based on unequal error protection according to the present invention. As shown in FIG. 23, on the basis of the embodiment shown in FIG. 22, in this embodiment, the processing module 42 includes:

a splitting unit 421, configured to perform code block splitting on the cascaded code blocks to obtain split code blocks;

a de-interleaving unit 422, configured to perform de-interleaving processing on the split code blocks to obtain de-interleaved code blocks;

a decoding unit 423, configured to perform decoding processing on the de-interleaved code blocks to obtain decoded code blocks; and

a check unit 424, configured to check the decoded code blocks to obtain the check code blocks.

The data transmission apparatus based on unequal error protection in this embodiment may be configured to execute the technical solution of the data transmission method based on unequal error protection provided in any embodiment of the present invention. An implementation principle and a technical effect of the data transmission apparatus are similar to those of the data transmission method, and details are not described herein again.

FIG. 24 is a schematic structural diagram of Embodiment 1 of a base station according to the present invention. As shown in FIG. 24, the base station provided in this embodiment of the present invention includes a processor 51 and a transmitter 52.

The processor 51 is configured to segment, according to a quantity of symbol bits in a constellation diagram, a code block corresponding to data, to obtain segmented code blocks.

The processor 51 is further configured to perform rate matching on the segmented code blocks obtained by channel encoding, to obtain output code blocks.

The processor 51 is further configured to cascade the output code blocks according to the quantity of symbol bits in the constellation diagram, to obtain cascaded code blocks.

The transmitter 52 is configured to send the cascaded code blocks to a terminal device.

The base station provided in this embodiment may be configured to execute the technical solution of the data transmission method based on unequal error protection provided in any embodiment of the present invention. An implementation principle and a technical effect of the base station are similar to those of the data transmission method, and details are not described herein again.

Optionally, the processor 51 is further configured to determine a segment quantity according to the quantity Qₘ of symbol bits in the constellation diagram, where the segment quantity is an integer multiple of Qₘ/2.

The processor 51 is further configured to segment the code block according to the segment quantity.

Optionally, the processor 51 is further configured to determine the segment quantity C′ according to a formula

$${C}^{′} = \frac{{Q}_{m}}{2} * ⌈ \frac{B}{( Z - L ) * {Q}_{m} / 2} ⌉ ,$$

where Z represents a maximum value of a code block size, B represents a magnitude of an input bit stream corresponding to the code block, and L represents a magnitude of a CRC parity bit.

Optionally, the processor 51 is further configured to use every Qₘ/2 output code blocks as a code block group, and sort the output code blocks in each code block group according to importance of the data.

The processor 51 is further configured to separately obtain one bit from each sorted output code block corresponding to each code block group and cascade the obtained bits, and repeat this operation until Qₘ bits are cascaded.

Optionally, the processor 51 is further configured to encode the segmented code blocks to obtain encoded code blocks.

The processor 51 is further configured to perform interleaving processing on the encoded code blocks by using an interleaver, to obtain interleaved code blocks.

The processor 51 is further configured to perform rate matching on the interleaved code blocks to obtain the output code blocks.

Optionally, the processor 51 is further configured to perform data modulation on the cascaded code blocks to obtain modulated data.

The processor 51 is further configured to perform digital-to-analog conversion on the modulated data to obtain analog data.

The transmitter 52 is further configured to send the analog data to the terminal device.

The base station provided in this embodiment may be configured to execute the technical solution of the data transmission method based on unequal error protection provided in any embodiment of the present invention. An implementation principle and a technical effect of the base station are similar to those of the data transmission method, and details are not described herein again.

FIG. 25 is a schematic structural diagram of Embodiment 2 of a base station according to the present invention. As shown in FIG. 25, the base station provided in this embodiment of the present invention includes a processor 61 and a transmitter 62.

The processor 61 is configured to segment, according to a preset parameter, a code block corresponding to data, to obtain segmented code blocks.

The processor 61 is further configured to perform encoding processing on the segmented code blocks to obtain encoded code blocks, where the encoded code blocks include system bit code blocks.

The processor 61 is further configured to perform interleaving processing on the system bit code blocks according to a quantity of symbol bits in a constellation diagram, to obtain interleaved code blocks.

The processor 61 is further configured to cascade the interleaved code blocks to obtain cascaded code blocks.

The transmitter 62 is configured to send the cascaded code blocks to a terminal device.

The base station provided in this embodiment may be configured to execute the technical solution of the data transmission method based on unequal error protection provided in any embodiment of the present invention. An implementation principle and a technical effect of the base station are similar to those of the data transmission method, and details are not described herein again.

Optionally, the processor 61 is further configured to determine a segment quantity, a length of a segmented code block, and a quantity of first padding bits according to the preset parameter, where the padding bit is a bit used when bit padding is performed on the code block.

The processor 61 is further configured to perform bit padding on the code block according to the segment quantity, the length of a segmented code block, and the quantity of first padding bits, so as to segment the code block.

Optionally, the processor 61 is further configured to determine a quantity of rows of an interleaver according to the quantity of symbol bits in the constellation diagram, and determine a quantity of second padding bits according to the quantity of rows of the interleaver and a preset quantity of columns of the interleaver.

The processor 61 is further configured to separately place the padding bit and an information bit according to the quantity of second padding bits and the quantity of symbol bits in the constellation diagram, where the information bit is a bit corresponding to the data.

The base station provided in this embodiment may be configured to execute the technical solution of the data transmission method based on unequal error protection provided in any embodiment of the present invention. An implementation principle and a technical effect of the base station are similar to those of the data transmission method, and details are not described herein again.

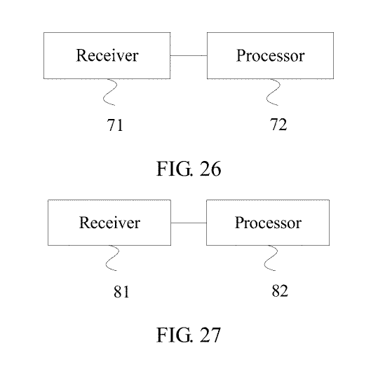

FIG. 26 is a schematic structural diagram of Embodiment 1 of a terminal device according to the present invention. As shown in FIG. 26, the terminal device provided in this embodiment of the present invention includes a receiver 71 and a processor 72.

The receiver 71 is configured to receive cascaded code blocks sent by a base station, where the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram.

The processor 72 is configured to perform code block splitting on the cascaded code blocks according to the quantity of symbol bits in the constellation diagram, to obtain split code blocks.

The processor 72 is further configured to perform code block cascading on the split code blocks obtained by channel decoding, to obtain the data.

The terminal device provided in this embodiment may be configured to execute the technical solution of the data transmission method based on unequal error protection provided in any embodiment of the present invention. An implementation principle and a technical effect of the terminal device are similar to those of the data transmission method, and details are not described herein again.

Optionally, the processor 72 is further configured to use every Qₘ/2 bits in the cascaded code blocks as a bit group, sequentially obtain one bit from each bit group, and form a bit stream by using the obtained bits.

Optionally, the processor 72 is further configured to perform de-interleaving processing on the split code blocks by using a de-interleaver, to obtain de-interleaved code blocks.

The processor 72 is further configured to perform decoding processing on the de-interleaved code blocks to obtain decoded code blocks.

The processor 72 is further configured to sequentially perform CRC check and code block cascading processing on the decoded code blocks, to obtain the data.

The terminal device provided in this embodiment may be configured to execute the technical solution of the data transmission method based on unequal error protection provided in any embodiment of the present invention. An implementation principle and a technical effect of the terminal device are similar to those of the data transmission method, and details are not described herein again.

FIG. 27 is a schematic structural diagram of Embodiment 2 of a terminal device according to the present invention. As shown in FIG. 27, the terminal device provided in this embodiment of the present invention includes a receiver 81 and a processor 82.

The receiver 81 is configured to receive cascaded code blocks sent by a base station, where the cascaded code blocks are obtained after a code block corresponding to data is segmented according to a preset parameter, encoding processing is performed on the obtained segmented code blocks to obtain encoded code blocks, where the encoded code blocks include system bit code blocks, interleaving processing is performed on the system bit code blocks according to a quantity of symbol bits in a constellation diagram to obtain interleaved code blocks, and the interleaved code blocks are cascaded.

The processor 82 is configured to perform LTE data receiving processing on the cascaded code blocks to obtain check code blocks.

The processor 82 is further configured to perform row-in-column-out code block cascading on the check code blocks to obtain cascaded code blocks.

The terminal device provided in this embodiment may be configured to execute the technical solution of the data transmission method based on unequal error protection provided in any embodiment of the present invention. An implementation principle and a technical effect of the terminal device are similar to those of the data transmission method, and details are not described herein again.

Optionally, the processor 82 is further configured to perform code block splitting on the cascaded code blocks to obtain split code blocks.

The processor 82 is further configured to perform de-interleaving processing on the split code blocks to obtain de-interleaved code blocks.

The processor 82 is further configured to perform decoding processing on the de-interleaved code blocks to obtain decoded code blocks.

The processor 82 is further configured to check the decoded code blocks to obtain the check code blocks.

The terminal device provided in this embodiment may be configured to execute the technical solution of the data transmission method based on unequal error protection provided in any embodiment of the present invention. An implementation principle and a technical effect of the terminal device are similar to those of the data transmission method, and details are not described herein again.

It may be clearly understood by a person skilled in the art that, for the purpose of convenient and brief description, division of the foregoing function modules is taken as an example for illustration. In actual application, the foregoing functions can be allocated to different function modules and implemented according to a requirement, that is, an inner structure of an apparatus is divided into different function modules to implement all or some of the functions described above. For a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or a part of the technical solutions may be implemented in the form of a software product. The software product is stored in a storage medium and includes several instructions for instructing a computer device (which may be a personal computer, a server, or a network device) or a processor (processor) to perform all or a part of the steps of the methods described in the embodiments of this application. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing embodiments are merely intended for describing the technical solutions of this application, but not for limiting this application. Although this application is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. A data transmission method based on unequal error protection, comprising:
segmenting, according to a quantity of symbol bits in a constellation diagram, a code block corresponding to data, to obtain segmented code blocks;
performing rate matching on the segmented code blocks obtained by channel encoding, to obtain output code blocks;
cascading the output code blocks according to the quantity of symbol bits in the constellation diagram, to obtain cascaded code blocks; and
sending the cascaded code blocks to a terminal device.

2. The method according to claim 1, wherein the segmenting, according to the quantity of symbol bits in the constellation diagram, the code block corresponding to data comprises:
determining a segment quantity according to the quantity of symbol bits in the constellation diagram, wherein Qₘ represents the quantity of symbol bits, and the segment quantity is an integer multiple of Qₘ/2; and
segmenting the code block according to the segment quantity.

3. The method according to claim 2, wherein the determining the segment quantity according to the quantity of symbol bits in the constellation diagram comprises:
determining the segment quantity according to a formula
$${C}^{′} = \frac{{Q}_{m}}{2} * ⌈ \frac{B}{( Z - L ) * {Q}_{m} / 2} ⌉ ,$$
wherein C′ represents the segment quantity, Z represents a maximum value of a code block size, B represents a magnitude of an input bit stream corresponding to the code block, and L represents a magnitude of a CRC parity bit.

4. The method according to claim 2, wherein the cascading the output code blocks according to the quantity of symbol bits in the constellation diagram comprises:
using every Qₘ/2 output code blocks as a code block group;
sorting the output code blocks in each code block group according to importance of the data;
separately obtaining one bit from each sorted output code block corresponding to each code block group;
cascading the obtained bits; and
repeating the separately obtaining the one bit and the cascading the obtained bits until Qₘ bits are cascaded.

5. The method according to claim 1, wherein the performing rate matching on the segmented code blocks obtained by channel encoding comprises:
encoding the segmented code blocks to obtain encoded code blocks;
performing interleaving processing on the encoded code blocks by using an interleaver, to obtain interleaved code blocks; and
performing rate matching on the interleaved code blocks to obtain the output code blocks.

6. The method according to claim 1, wherein the sending the cascaded code blocks to a terminal device comprises:
performing data modulation on the cascaded code blocks to obtain modulated data;
performing digital-to-analog conversion on the modulated data to obtain analog data; and
sending the analog data to the terminal device.

7. A data transmission method based on unequal error protection, comprising:
receiving cascaded code blocks sent by a base station, wherein the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram;
performing code block splitting on the cascaded code blocks according to the quantity of symbol bits in the constellation diagram, to obtain split code blocks; and
performing code block cascading on the split code blocks obtained by channel decoding, to obtain the data.

8. The method according to claim 7, wherein the performing code block splitting on the cascaded code blocks according to the quantity of symbol bits in the constellation diagram comprises:
using every Qₘ/2 bits in the cascaded code blocks as a bit group, wherein Qₘ represents the quantity of symbol bits;
sequentially obtaining one bit from each bit group; and
forming a bit stream by using the obtained bits.

9. The method according to claim 7, wherein the performing code block cascading on the split code blocks obtained by channel decoding comprises:
performing de-interleaving processing on the split code blocks by using a de-interleaver, to obtain de-interleaved code blocks;
performing decoding processing on the de-interleaved code blocks to obtain decoded code blocks; and
sequentially performing CRC check and code block cascading processing on the decoded code blocks, to obtain the data.

10. A base station, comprising:
a processor, configured to:
segment, according to a quantity of symbol bits in a constellation diagram, a code block corresponding to data, to obtain segmented code blocks;
perform rate matching on the segmented code blocks obtained by channel encoding, to obtain output code blocks; and
cascade the output code blocks according to the quantity of symbol bits in the constellation diagram, to obtain cascaded code blocks; and
a transmitter communicatively coupled with the processor, wherein the transmitter is configured to send the cascaded code blocks to a terminal device.

11. The base station according to claim 10, wherein the processor is further configured to:
determine a segment quantity according to the quantity of symbol bits in the constellation diagram, wherein Qₘ represents the quantity of symbol bits, and the segment quantity is an integer multiple of Qₘ/2; and
segment the code block according to the segment quantity.

12. The base station according to claim 11, wherein the processor is further configured to determine the segment quantity according to a formula
$${C}^{′} = \frac{{Q}_{m}}{2} * ⌈ \frac{B}{( Z - L ) * {Q}_{m} / 2} ⌉ ,$$
wherein C′ represents the segment quantity, Z represents a maximum value of a code block size, B represents a magnitude of an input bit stream corresponding to the code block, and L represents a magnitude of a CRC parity bit.

13. The base station according to claim 11, wherein the processor is further configured to:
use every Qₘ/2 output code blocks as a code block group;
sort the output code blocks in each code block group according to importance of the data;
separately obtain one bit from each sorted output code block corresponding to each code block group;
cascade the obtained bits; and
repeat the separately obtaining the one bit and the cascading the obtained bits until Qₘ bits are cascaded.

14. The base station according to claim 10, wherein the processor is further configured to:
encode the segmented code blocks to obtain encoded code blocks;
perform interleaving processing on the encoded code blocks by using an interleaver, to obtain interleaved code blocks; and
perform rate matching on the interleaved code blocks to obtain the output code blocks.

15. The base station according to claim 10, wherein
the processor is further configured to:
perform data modulation on the cascaded code blocks to obtain modulated data; and
perform digital-to-analog conversion on the modulated data to obtain analog data; and
the transmitter is further configured to send the analog data to the terminal device.

16. A terminal device, comprising:
a receiver, configured to receive cascaded code blocks sent by a base station, wherein the cascaded code blocks are obtained after a code block corresponding to data is segmented according to a quantity of symbol bits in a constellation diagram, rate matching is performed on the segmented code blocks obtained by channel encoding to obtain output code blocks, and the output code blocks are cascaded according to the quantity of symbol bits in the constellation diagram; and
a processor coupled with the receiver, wherein the processor is configured to:
perform code block splitting on the cascaded code blocks according to the quantity of symbol bits in the constellation diagram, to obtain split code blocks; and
perform code block cascading on the split code blocks obtained by channel decoding, to obtain the data.

17. The terminal device according to claim 16, wherein the processor is further configured to:
use every Qₘ/2 bits in the cascaded code blocks as a bit group, wherein Qₘ represents the quantity of symbol bits;
sequentially obtain one bit from each bit group; and
form a bit stream by using the obtained bits.

18. The terminal device according to claim 16, wherein the processor is further configured to:
perform de-interleaving processing on the split code blocks by using a de-interleaver, to obtain de-interleaved code blocks;
perform decoding processing on the de-interleaved code blocks to obtain decoded code blocks; and
sequentially perform CRC check and code block cascading processing on the decoded code blocks, to obtain the data.
